(19) United States
(12) Patent Application Publication
(10) Pub. No.: US 2016/0122187 A1
(43) Pub. Date: May 5, 2016

(54) Process for Covalently Grafting a Carbonaceous Material

(71) Applicant: TOTAL RESEARCH & TECHNOLOGY FELUY, Seneffe (BE)

(72) Inventors: Olivier LHOST, Havré (BE); Claire BOUVY, Moignelée (BE); Simon DETRICHE, Bolinne-Harlue (BE); Joseph DELHALLE, Noville-les-bois (Fernelmont) (BE); Zineb MEKHALIF, Namur (BE); Magali VACHAUDEZ, Neufmaison (BE); Thomas DEVAHIF, Huy (BE)

(73) Assignee: TOTAL RESEARCH & TECHNOLOGY FELUY, SENEFFE (BE)

(21) Appl. No.: 14/890,443

(22) PCT Filed: May 16, 2014
(86) PCT No.: PCT/EP2014/060043

§ 371 Date: Nov. 11, 2015

(30) Foreign Application Priority Data
May 16, 2013 (EP) 13168065.4

(51) Int. Cl. C01B 31/02; C08K 9/04

(52) U.S. Cl. CPC C01B 31/0253; C08K 9/04

(57) ABSTRACT

A process for preparing covalently grafted carbonaceous material includes providing carbonaceous material, providing at least one reactant, and mixing the carbonaceous material with the at least one reactant to obtain a mixture. The process includes irradiating the mixture under IR radiation to obtain the covalently grafted carbonaceous material.

### FIELD OF THE INVENTION

The present invention relates to a process for preparing a covalently grafted carbonaceous material. The present invention also relates to a process for preparing a nanocomposite comprising covalently grafted carbonaceous material.

### BACKGROUND OF THE INVENTION

Carbonaceous material such as carbonaceous nanoparticles offers interesting and frequently unexpected properties because its properties are rather the result of the surface of the particles than of the bulk volume. For example, nanoparticles can show surprising mechanical, optical and electrical properties, even at low concentrations. The properties of nanoparticles have attracted interest in polymer science, particularly for polymer reinforcement. Particular attention has been focused on carbon nanotubes (CNTs).

Grafting the nanotubes with a chemical functionality further improves the properties of the nanotubes, and opens the door to a whole range of applications. Traditionally, chemical grafting is performed through reactions such as: Friedel-Crafts, radical, amidation, diazoniums, fluoration, Diels-Alder, electrochemistry, plasma treatment, etc. However, the experimental conditions are not always suitable, realistic, or economically viable for large-scale industrial set-ups.

There remains a need to provide alternative and improved processes for the grafting of carbonaceous material with chemical functionalities. There remains a need for processes that can be performed under industrially realistic experimental conditions. There remains a need for processes that can be performed on large volumes (mass grafting). There remains a need for processes that can provide homogeneous grafting. There remains a need for processes that are efficient and cost-effective.

### SUMMARY OF THE INVENTION

It is therefore an object of the present invention to provide an improved process for preparing a covalently grafted carbonaceous material. It is also an object of the present invention to provide an improved process for preparing a nanocomposite comprising covalently grafted carbonaceous material. It is also an object of the present invention to provide a process for preparing a covalently grafted carbonaceous material that can be performed under industrially realistic experimental conditions. It is also an object of the present invention to provide a process for preparing a nanocomposite comprising covalently grafted carbonaceous material that can be performed under industrially realistic experimental conditions. It is also an object of the present invention to provide a process for preparing a covalently grafted carbonaceous material that can be performed on large volumes. It is also an object of the present invention to provide a process for preparing a nanocomposite comprising covalently grafted carbonaceous material that can be performed on large volumes. It is also an object of the present invention to provide a process for preparing a covalently grafted carbonaceous material that can provide homogeneous grafting. It is also an object of the present invention to provide a process for preparing a nanocomposite comprising covalently grafted carbonaceous material that can provide homogeneous grafting. It is also an object of the present invention to provide a process for preparing a covalently grafted carbonaceous material that is efficient and cost-effective. It is also an object of the present invention to provide a process for preparing a nanocomposite comprising covalently grafted carbonaceous material that is efficient and cost-effective.

The inventors have now discovered that these objects can be met either individually or in any combination by the present processes. The inventors have surprisingly found that by selecting the reactant (and optional co-reactant, solvent and/or co-solvent) and irradiating with IR, achieves good covalent grafting of chemical functionalities to carbonaceous material. Furthermore, the inventors have discovered that the present processes may show short time reactions. Furthermore, the inventors have discovered that the present processes may be performed under moderate and safe experimental conditions. Furthermore, the inventors have discovered that the present processes may provide a highly efficient method for grafting. Furthermore, the inventors have discovered that the present processes may provide a highly homogeneous method for grafting. Furthermore, the inventors have discovered that the present processes may provide a selective method for grafting. Furthermore, the inventors have discovered that the present processes may prevent shortening of the carbonaceous material, such as carbon nanotubes. Furthermore, the inventors have discovered that the present processes may provide a method for grafting on a large specimen volume, and may not be limited to the specimen surface compared to electrochemical grafting reactions.

According to a first aspect, the invention provides a process for preparing covalently grafted carbonaceous material, comprising the steps of:
(a) providing carbonaceous material;
(b) providing at least one reactant;
(c) mixing the carbonaceous material with the reactant, thereby obtaining a mixture; and
(d) irradiating the mixture obtained in step (c) under IR radiation;

thereby obtaining covalently grafted carbonaceous material.

According to a second aspect, the invention provides a process for preparing a polymeric composite, comprising the steps of:
(a) providing a polymer composition comprising at least one polymer; preferably comprising at least one polyolefin, preferably comprising polyethylene or polypropylene;
(b) providing at least 0.001% by weight of covalently grafted carbonaceous material prepared according to the process according to the first aspect of the invention, relative to the total weight of the polymeric composite;
(c) blending the covalently grafted carbonaceous material with the polymer composition, thereby obtaining a polymeric composite.

According to a third aspect, the invention encompasses the covalently grafted carbonaceous material obtained by a process according to the first aspect of the invention. According to a fourth aspect, the invention encompasses the polymeric composite obtained by the process according to the second aspect of the invention.

The independent and dependent claims set out particular and preferred features of the invention. Features from the dependent claims may be combined with features of the independent or other dependent claims as appropriate.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### DETAILED DESCRIPTION OF THE INVENTION

Before the present processes of the invention are described, it is to be understood that this invention is not limited to particular processes described, since such processes may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise. By way of example, “a reactant” means one reactant or more than one reactant.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The term “hydrocarbyl having 1 to 20 carbon atoms” as used herein is intended to refer to a moiety selected from the group comprising a linear or branched C₁-C₂₀ alkyl; C₃-C₂₀ cycloalkyl; C₆-C₂₀ aryl; C₇-C₂₀ alkylaryl and C₇-C₂₀ arylalkyl, or any combinations thereof. Exemplary hydrocarbyl groups are methyl, ethyl, propyl, butyl, amyl, isoamyl, hexyl, isobutyl, heptyl, octyl, nonyl, decyl, cetyl, 2-ethylhexyl, and phenyl. Any hydrocarbyl moiety may be substituted with a halogen atom. Exemplary halogen atoms include chlorine, bromine, fluorine and iodine and of these halogen atoms, fluorine and chlorine are preferred.

The term “C₁₋₂₄ alkyl”, as a group or part of a group, refers to a hydrocarbyl radical of Formula CₙH₂ₙ₊₁ wherein n is a number ranging from 1 to 24. Generally, the alkyl groups comprise from 1 to 20 carbon atoms, preferably from 1 to 12 carbon atoms, preferably from 1 to 10 carbon atoms, preferably from 1 to 6 carbon atoms, more preferably 1, 2, 3, 4, 5, 6 carbon atoms. Alkyl groups may be linear, or branched and may be substituted as indicated herein. When a subscript is used herein following a carbon atom, the subscript refers to the number of carbon atoms that the named group may contain. Thus, for example, C₁₋₂₄ alkyl groups include all linear, or branched alkyl groups having 1 to 24 carbon atoms, and thus includes for example methyl, ethyl, n-propyl, i-propyl, 2-methyl-ethyl, butyl and its isomers (e.g. n-butyl, i-butyl and t-butyl); pentyl and its isomers, hexyl and its isomers, heptyl and its isomers, octyl and its isomers, nonyl and its isomers, decyl and its isomers, undecyl and its isomers, dodecyl and its isomers, tridecyl and its isomers, tetradecyl and its isomers, pentadecyl and its isomers, hexadecyl and its isomers, heptadecyl and its isomers, octadecyl and its isomers, nonadecyl and its isomers, icosyl and its isomers, and the like. For example, C₁₋₁₀alkyl includes all linear, or branched alkyl groups having 1 to 10 carbon atoms, and thus includes for example methyl, ethyl, n-propyl, i-propyl, 2-methyl-ethyl, butyl and its isomers (e.g. n-butyl, i-butyl and t-butyl); pentyl and its isomers, hexyl and its isomers, heptyl and its isomers, octyl and its isomers, nonyl and its isomers, decyl and its isomers and the like. For example, C₁₋₆alkyl includes all linear, or branched alkyl groups having 1 to 6 carbon atoms, and thus includes for example methyl, ethyl, n-propyl, i-propyl, 2-methyl-ethyl, butyl and its isomers (e.g. n-butyl, i-butyl and t-butyl); pentyl and its isomers, hexyl and its isomers. When the suffix “ene” is used in conjunction with an alkyl group, i.e. “alkylene”, this is intended to mean the alkyl group as defined herein having two single bonds as points of attachment to other groups.

As used herein, the term “C₂₋₂₄alkenyl” as a group or part of a group, refers to an unsaturated hydrocarbyl group, which may be linear, or branched, comprising one or more carbon-carbon double bonds; comprising from 2 to 24 carbon atoms. Preferred alkenyl groups comprise from 2 to 8 carbon atoms. Non-limiting examples of C₂₋₈alkenyl groups include 2-propenyl, 2-butenyl, 3-butenyl, 2-pentenyl and its chain isomers, 2-hexenyl and its chain isomers, 2-heptenyl and its chain isomers, 2-octenyl and its chain isomers, 2,4-pentadienyl and the like.

The term “C₆₋₁₀aryl”, as a group or part of a group, refers to a polyunsaturated, aromatic hydrocarbyl group having a single ring (i.e. phenyl) or multiple aromatic rings fused together (e.g. naphthalene), or linked covalently, typically containing 6 to 10 atoms; wherein at least one ring is aromatic. Non-limiting examples of C₆₋₁₁₀aryl comprise phenyl, indanyl, or 1- or 2-naphthanelyl; or 1,2,3,4-tetrahydro-naphthyl.

The term “C₆₋₁₀arylC₁₋₆alkyl”, as a group or part of a group, means a C₁₋₆alkyl as defined herein, wherein at least one hydrogen atom is replaced by at least one C₆₋₁₀aryl as defined herein. Non-limiting examples of C₆₋₁₀arylC₁₋₆alkyl group include benzyl, phenethyl, dibenzylmethyl, methylphenylmethyl, 3-(2-naphthyl)-butyl, and the like.

The term “C₁₋₆alkylC₆₋₁₀aryl”, as a group or part of a group, means a C₆₋₁₀aryl as defined herein, wherein at least one hydrogen atom is replaced by at least one C₁₋₆alkyl as defined herein.

The term “halo” or “halogen”, as a group or part of a group, is generic for fluoro, chloro, bromo or iodo.

The term “haloC₁₋₁₀alkyl”, as a group or part of a group, refers to a C₁₋₁₀alkyl group having the meaning as defined above wherein one or more hydrogens are replaced with a halogen as defined above. Non-limiting examples of such haloC₁₋₁₀alkyl radicals include CH₂Cl—, CH₂Br—, CH₂F—, CHF₂, and groups of formula CF₃—(CY₂)_{z}—, wherein Y is H or F and z is an integer selected from 0, 1, 2, 3, 4, 5, 6, 7, 8, or 9; such as for example, CF₃—, CF₃—CF₂—, CF₃—CH₂—, CF₃—(CF₂)₂—, CF₃—(CH₂)₂—, CF₃—(CF₂)₃—, CF₃—(CH₂)₃—, CF₃—(CF₂)₄—, CF₃—(CH₂)₄—, CF₃—(CF₂)₅—, CF₃—(CH₂)₅—, CF₃—(CF₂)₆—, CF₃—(CF₂)₇—, CF₃—(CF₂)₈—, and the like.

The term “heteroaryl” as used herein by itself or as part of another group refers but is not limited to 5 to 12 carbon-atom aromatic rings or ring systems containing 1 to 2 rings which are fused together or linked covalently, typically containing 5 to 6 atoms; at least one of which is aromatic in which one or more carbon atoms in one or more of these rings can be replaced by oxygen, nitrogen or sulfur atoms where the nitrogen and sulfur heteroatoms may optionally be oxidized and the nitrogen heteroatoms may optionally be quaternized. Such rings may be fused to an aryl, cycloalkyl, heteroaryl or heterocyclyl ring. Non-limiting examples of such heteroaryl, include: pyrrolyl, furanyl, thiophenyl, pyrazolyl, imidazolyl, oxazolyl, isoxazolyl, thiazolyl, isothiazolyl, triazolyl, oxadiazolyl, thiadiazolyl, tetrazolyl, oxatriazolyl, thiatriazolyl, pyridinyl, pyrimidyl, pyrazinyl, pyridazinyl, oxazinyl, dioxinyl, thiazinyl, triazinyl. Preferably the heteroaryl is selected from pyrrolyl, furanyl, thiophenyl, pyrazolyl, imidazolyl, oxazolyl, isoxazolyl, triazolyl, oxadiazolyl, tetrazolyl, oxatriazolyl, pyridinyl, pyrimidyl, pyrazinyl, pyridazinyl, more preferably pyrrolyl, pyrazolyl, imidazolyl, pyridinyl, pyrimidyl, pyrazinyl, yet more preferably pyrrolyl. The term “pyrrolyl” (also called azolyl) as used herein includes pyrrol-1-yl, pyrrol-2-yl and pyrrol-3-yl. The term “furanyl” (also called “furyl”) as used herein includes furan-2-yl and furan-3-yl (also called furan-2-yl and furan-3-yl). The term “thiophenyl” (also called “thienyl”) as used herein includes thiophen-2-yl and thiophen-3-yl (also called thien-2-yl and thien-3-yl). The term “pyrazolyl” (also called 1H-pyrazolyl and 1,2-diazolyl) as used herein includes pyrazol-1-yl, pyrazol-3-yl, pyrazol-4-yl and pyrazol-5-yl. The term “imidazolyl” as used herein includes imidazol-1-yl, imidazol-2-yl, imidazol-4-yl and imidazol-5-yl. The term “oxazolyl” (also called 1,3-oxazolyl) as used herein includes oxazol-2-yl; oxazol-4-yl and oxazol-5-yl. The term “isoxazolyl” (also called 1,2-oxazolyl), as used herein includes isoxazol-3-yl, isoxazol-4-yl, and isoxazol-5-yl. The term “thiazolyl” (also called 1,3-thiazolyl), as used herein includes thiazol-2-yl, thiazol-4-yl and thiazol-5-yl (also called 2-thiazolyl, 4-thiazolyl and 5-thiazolyl). The term “isothiazolyl” (also called 1,2-thiazolyl) as used herein includes isothiazol-3-yl, isothiazol-4-yl, and isothiazol-5-yl. The term “triazolyl” as used herein includes 1H-triazolyl and 4H-1,2,4-triazolyl, “1H-triazolyl” includes 1H-1,2,3-triazol-1-yl, 1H-1,2,3-triazol-4-yl, 1H-1,2,3-triazol-5-yl, 1H-1,2,4-triazol-1-yl, 1H-1,2,4-triazol-3-yl and 1H-1,2,4-triazol-5-yl. “4H-1,2,4-triazolyl” includes 4H-1,2,4-triazol-4-yl, and 4H-1,2,4-triazol-3-yl. The term “oxadiazolyl” as used herein includes 1,2,3-oxadiazol-4-yl, 1,2,3-oxadiazol-5-yl, 1,2,4-oxadiazol-3-yl, 1,2,4-oxadiazol-5-yl, 1,2,5-oxadiazol-3-yl and 1,3,4-oxadiazol-2-yl. The term “thiadiazolyl” as used herein includes 1,2,3-thiadiazol-4-yl, 1,2,3-thiadiazol-5-yl, 1,2,4-thiadiazol-3-yl, 1,2,4-thiadiazol-5-yl, 1,2,5-thiadiazol-3-yl (also called furazan-3-yl) and 1,3,4-thiadiazol-2-yl. The term “tetrazolyl” as used herein includes 1H-tetrazol-1-yl, 1H-tetrazol-5-yl, 2H-tetrazol-2-yl, and 2H-tetrazol-5-yl. The term “oxatriazolyl” as used herein includes 1,2,3,4-oxatriazol-5-yl and 1,2,3,5-oxatriazol-4-yl. The term “thiatriazolyl” as used herein includes 1,2,3,4-thiatriazol-5-yl and 1,2,3,5-thiatriazol-4-yl. The term “pyridinyl” (also called “pyridyl”) as used herein includes pyridin-2-yl, pyridin-3-yl and pyridin-4-yl (also called 2-pyridyl, 3-pyridyl and 4-pyridyl). The term “pyrimidyl” as used herein includes pyrimid-2-yl, pyrimid-4-yl, pyrimid-5-yl and pyrimid-6-yl. The term “pyrazinyl” as used herein includes pyrazin-2-yl and pyrazin-3-yl. The term “pyridazinyl as used herein includes pyridazin-3-yl and pyridazin-4-yl. The term “oxazinyl” (also called “1,4-oxazinyl”) as used herein includes 1,4-oxazin-4-yl and 1,4-oxazin-5-yl. The term “dioxinyl” (also called “1,4-dioxinyl”) as used herein includes 1,4-dioxin-2-yl and 1,4-dioxin-3-yl. The term “thiazinyl” (also called “1,4-thiazinyl”) as used herein includes 1,4-thiazin-2-yl, 1,4-thiazin-3-yl, 1,4-thiazin-4-yl, 1,4-thiazin-5-yl and 1,4-thiazin-6-yl. The term “triazinyl” as used herein includes 1,3,5-triazin-2-yl, 1,2,4-triazin-3-yl, 1,2,4-triazin-5-yl, 1,2,4-triazin-6-yl, 1,2,3-triazin-4-yl and 1,2,3-triazin-5-yl.

As used herein, the term “hydrocarbyl having 1 to 20 carbon atoms” refers to a moiety selected from the group comprising a linear or branched C₁-C₂₀ alkyl; C₃-C₂₀ cycloalkyl; C₆-C₂₀ aryl; C₇-C₂₀ alkylaryl and C₇-C₂₀ arylalkyl, or any combinations thereof. Exemplary hydrocarbyl groups are methyl, ethyl, propyl, butyl, amyl, isoamyl, hexyl, isobutyl, heptyl, octyl, nonyl, decyl, cetyl, 2-ethylhexyl, and phenyl.

As used herein, the term “hydrocarboxy having 1 to 20 carbon atoms” refers to a moiety with the formula hydrocarbyl-O—, wherein the hydrocarbyl has 1 to 20 carbon atoms as described herein. Preferred hydrocarboxy groups are selected from the group comprising alkyloxy, alkenyloxy, cycloalkyloxy or aralkoxy groups.

All references cited in the present specification are hereby incorporated by reference in their entirety. In particular, the teachings of all references herein specifically referred to are incorporated by reference.

According to a first aspect, the invention provides a process for preparing covalently grafted carbonaceous material, comprising the steps of:
(a) providing carbonaceous material;
(b) providing at least one reactant;
(c) mixing the carbonaceous material with the reactant, thereby obtaining a mixture; and
(d) irradiating the mixture obtained in step (c) under IR radiation;

thereby obtaining covalently grafted carbonaceous material.

In a preferred embodiment, the carbonaceous material comprises carbonaceous nanoparticles, for example selected from the group comprising carbon nanotubes, fullerenes, carbon black, nanographene, and nanographite. In a preferred embodiment, the carbonaceous material is selected from the group comprising carbon nanotubes, fullerenes, carbon black, nanographene, and nanographite. Preferably, the carbonaceous material comprises carbon nanotubes.

The nanoparticles used in the present invention can generally be characterized by having a size from 1 nm to 500 nm. In the case of, for example, nanotubes, this definition of size can be limited to two dimensions only, i.e. the third dimension may be outside of these limits. Preferably, the nanoparticles are selected from the group comprising nanotubes, nanofibers, carbon black, nanographene, nanographite, and blends of these. More preferred are nanotubes, nanofibers, and blends of these. Most preferred are nanotubes.

In a preferred embodiment, the carbonaceous material comprises carbon nanotubes, preferably wherein the carbonaceous material comprises multi-walled carbon nanotubes.

In an embodiment, the invention relates to a process for preparing covalently grafted carbonaceous material such as covalently grafted carbon nanotubes, comprising the steps of:
(a) providing carbon nanotubes;
(b) providing at least one reactant;
(c) mixing the carbon nanotubes with the at least one reactant, thereby obtaining a mixture; and
(d) irradiating the mixture obtained in step (c) under IR radiation;

thereby obtaining covalently grafted carbon nanotubes.

Suitable nanotubes to be used in the invention can be cylindrical in shape and structurally related to fullerenes, an example of which is Buckminster fullerene (C₆₀). Suitable nanotubes may be open or capped at their ends. The end cap may for example be a Buckminster-type fullerene hemisphere. The nanotubes made in the present invention may be made from elements of group 14 of the periodic table of the elements, such as carbon (carbon nanotubes or CNTs) or silicon (silicon nanotubes), or mixtures thereof, such as SiC nanotubes, or from a combination of elements of groups 13 and 15 of the periodic table of the elements (see International Union of Pure and Applied Chemistry (IUPAC) Periodic Table of the Elements), such as for example a combination of boron or aluminum with nitrogen or phosphorus. Suitable nanotubes may also be made from carbon and a combination of elements of groups 13, 14 and 15 of the periodic table of the elements. Suitable nanotubes may also be selected from the group comprising tungsten disulfide nanotubes, titanium dioxide nanotubes, molybdenum disulfide nanotubes, copper nanotubes, bismuth nanotubes, cerium dioxide nanotubes, zinc oxide nanotubes, and mixtures thereof.

Preferably the nanotubes used in the present invention are made from carbon, i.e. they comprise more than 90%, more preferably more than 95%, even more preferably more than 99% and most preferably more than 99.9% of their total weight in carbon; such nanotubes are generally referred to as “carbon nanotubes” (CNT). According to a preferred embodiment of the invention, the nanoparticles are carbon nanotubes. However, minor amounts of other atoms may also be present.

Suitable carbon nanotubes to be used in the present invention can be prepared by any method known in the art. They can be prepared by the catalyst decomposition of hydrocarbons, a technique that is called Catalytic Carbon Vapor Deposition (CCVD). Other methods for preparing carbon nanotubes include the arc-discharge method, the plasma decomposition of hydrocarbons or the pyrolysis of selected polyolefin under selected oxidative conditions. The starting hydrocarbons can be acetylene, ethylene, butane, propane, ethane, methane or any other gaseous or volatile carbon-containing compound. The catalyst, if present, is used in either pure or in supported form. The presence of a support greatly improves the selectivity of the catalysts but it contaminates the carbon nanotubes with support particles, in addition to the soot and amorphous carbon prepared during pyrolysis. Purification can remove these by-products and impurities. This can be carried out according to the following two steps:

1) the dissolution of the support particles, typically carried out with an appropriate agent that depends upon the nature of the support and

2) the removal of the pyrolytic carbon component, typically based on either oxidation or reduction processes.

Nanotubes can exist as single-walled nanotubes (SWNT) and multi-walled nanotubes (MWNT), i.e. nanotubes having one single wall and nanotubes having more than one wall, respectively. In single-walled nanotubes a one atom thick sheet of atoms, for example a one atom thick sheet of nanographite (also called graphene), is rolled seamlessly to form a cylinder. Multi-walled nanotubes consist of a number of such cylinders arranged concentrically. The arrangement in a multi-walled nanotube can be described by the so-called Russian doll model, wherein a larger doll opens to reveal a smaller doll.

In an embodiment, the nanoparticles are multi-walled carbon nanotubes, more preferably multi-walled carbon nanotubes having on average from 5 to 15 walls.

Nanotubes, irrespectively of whether they are single-walled or multi-walled, may be characterized by their outer diameter or by their length or by both.

Single-walled nanotubes are preferably characterized by an outer diameter of at least 0.5 nm, more preferably of at least 1.0 nm, and most preferably of at least 2.0 nm. Preferably their outer diameter is at most 50 nm, more preferably at most 30 nm and most preferably at most 10 nm. In some embodiments, their outer diameter is at least 0.5 nm and at most 50 nm, for example at least 1.0 nm and most 30 nm, for example at least 2.0 nm and at most 10 nm. Preferably, the length of single-walled nanotubes is at least 0.1 μm, more preferably at least 1.0 μm. Preferably, their length is at most 50 μm, more preferably at most 25 μm. In some embodiments, their length is at least 0.1 μm and at most 50 μm, for example at least 1.0 μm and at most 25 μm.

Multi-walled nanotubes are preferably characterized by an outer diameter of at least 1.0 nm, more preferably of at least 2.0 nm, 4.0 nm, 6.0 nm or 8.0 nm, and most preferably of at least 10.0 nm. The preferred outer diameter is at most 100 nm, more preferably at most 80 nm, 60 nm or 40 nm, and most preferably at most 20 nm. In some embodiments, the outer diameter is in the range from 1.0 nm to 100 nm, for example from 2.0 nm to 80 nm, for example from 4.0 nm to 60 nm, for example from 6.0 to 60 nm, for example from 8.0 to 40 nm, preferably from 10.0 nm to 20 nm. The preferred length of the multi-walled nanotubes is at least 50 nm, more preferably at least 75 nm, and most preferably at least 100 nm. Their preferred length is at most 20 mm, more preferably at most 10 mm, 500 μm, 250 μm, 100 μm, 75 μm, 50 μm, 40 μm, 30 μm or 20 μm, and most preferably at most 10 μm. The most preferred length is in the range from 100 nm to 10 μm. In an embodiment, the multi-walled carbon nanotubes have an average outer diameter in the range from 10 nm to 20 nm or an average length in the range from 100 nm to 10 μm or both.

Non-limiting examples of commercially available multi-walled carbon nanotubes are Graphistrength™ 100, available from Arkema, and Nanocyl™ NC 7000, available from Nanocyl.

In an embodiment, the nanoparticles are nanofibers. Suitable nanofibers for use in the present invention preferably have a diameter of at least 1 nm, more preferably of at least 2 nm and most preferably of at least 5 nm. Preferably, their diameter is at most 500 nm, more preferably at most 300 nm, and most preferably at most 100 nm. In some embodiments, their diameter is at least 1 nm and at most 500 nm, for example at least 2 nm and at most 300 nm, for example at least 5 nm and at most 100 nm. Their length may vary from 10 μm to several centimeters.

Preferably, the nanofibers used in the present invention are carbon nanofibers, i.e. they comprise at least 50% by weight of carbon, relative to the total weight of the nanofiber. Preferably, suitable nanofibers used in the present invention comprise polyolefins, polyamides, polystyrenes, or polyesters as well as polyurethanes, polycarbonates, polyacrylonitrile, polyvinyl alcohol, polymethacrylate, polyethylene oxide, polyvinylchloride, or any blend thereof.

Suitable nanofibers for the present invention can be prepared by any suitable method, such as for example by drawing of a melt-spun or solution-spun fiber, by template synthesis, phase separation, self-assembly, electrospinning of a polyolefin solution or electrospinning of a polyolefin melt.

In an embodiment, the nanoparticles are carbon black particles. Carbon black is made of microcrystalline, finely dispersed carbon particles, which are obtained through incomplete combustion or thermal decomposition of liquid or gaseous hydrocarbons. Carbon black particles are characterized by a diameter in the range of from 5 nm to 500 nm, though they have a great tendency to form agglomerates. Carbon black comprises from 96% to 99% by weight of carbon, relative to its total weight, with the remainder being hydrogen, nitrogen, oxygen, sulfur or any combination of these. The surface properties of carbon black can be dominated by oxygen-comprising functional groups, such as hydroxyl, carboxyl or carbonyl groups, located on its surface.

In an embodiment, the nanoparticles are nanographene. Graphene in general, and including nanographene, may be a single sheet or a stack of several sheets having both micro- and nano-scale dimensions, such as in some embodiments an average particle size of 1 to 20 μm, specifically 1 to 15 μm, and an average thickness (smallest) dimension in nano-scale dimensions of less than or equal to 50 nm, specifically less than or equal to 25 nm, and more specifically less than or equal to 10 nm. An exemplary nanographene may have an average particle size of 1 to 5 μm, and specifically 2 to 4 μm. Graphene, including nanographene, may be prepared by exfoliation of nanographite or by a synthetic procedure by “unzipping” a nanotube to form a nanographene ribbon. Exfoliation to form graphene or nanographene may be carried out by exfoliation of a graphite source such as graphite, intercalated graphite, and nanographite. Exemplary exfoliation methods include, but are not limited to, those practiced in the art such as fluorination, acid intercalation, acid intercalation followed by thermal shock treatment, and the like, or a combination comprising at least one of the foregoing. Exfoliation of the nanographite provides a nanographene having fewer layers than non-exfoliated nanographite. It will be appreciated that exfoliation of nanographite may provide the nanographene as a single sheet only one molecule thick, or as a layered stack of relatively few sheets. In an embodiment, exfoliated nanographene has fewer than 50 single sheet layers, specifically fewer than 20 single sheet layers, specifically fewer than 10 single sheet layers, and more specifically fewer than 5 single sheet layers. In an embodiment, the nanographene has an aspect ratio in the range of greater than or equal to about 100:1, for example, greater than equal to about 1000:1. In an embodiment, the nanographene has a surface area greater than or equal to about 40 m²/gram nitrogen surface adsorption area. For example, the surface area is greater than or equal to about 100 m²/gram nitrogen surface adsorption area. In an embodiment, the nanographene is expanded.

In an embodiment, the nanoparticles are nanographite. The nanographite can be multilayered by furnace high temperature expansion from acid-treated natural graphite or microwave heating expansion from moisture saturated natural graphite. In an embodiment, the nanographite is a multi-layered nanographite which has at least one dimension with a thickness less than 100 nm. In some exemplary embodiments, the graphite may be mechanically treated such as by air jet milling to pulverize the nanographite particles. The pulverization of the particles ensures that the nanographite flake and other dimensions of the particles are less than 20 microns, most likely less than 5 microns.

In a preferred embodiment, the reactant is selected from the group comprising R¹—NH₂, R²—CH═CH₂, R³—Si(OR⁴)₃, (R⁵)₃—SiOR⁶, and R⁷≡N⁺≡N X⁻, lactide, polylactide, preferably wherein the reactant is R¹—NH₂ or R⁷—N⁺≡N X⁻, for example wherein the reactant is R¹—NH₂, for example wherein the reactant is R⁷—N⁺≡N X⁻;

wherein R¹ is selected from the group comprising C₆₋₁₀aryl, C₁₋₂₄alkyl, C₂₋₂₄alkenyl, C₆₋₁₀aryl-C₁₋₆alkyl and C₁₋₆alkyl-C₆₋₁₀aryl, and wherein R¹ may be optionally substituted with one or more substituents each independently selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, —NO₂, heteroaryl (such as pyrrolyl, furanyl, thiophenyl, pyrazolyl, imidazolyl, oxazolyl, isoxazolyl, triazolyl, oxadiazolyl, tetrazolyl, oxatriazolyl, pyridinyl, pyrimidyl, pyrazinyl, pyridazinyl, more preferably pyrrolyl, pyrazolyl, imidazolyl, pyridinyl, pyrimidyl, pyrazinyl, yet more preferably pyrrolyl), C₁₋₂₄alkyl, C₂₋₂₄alkenyl, C₆₋₁₀aryl, C₁₋₆alkyl-C₆₋₁₀aryl, and halogen; preferably wherein R¹ is (optionally substituted) C₆₋₁₀aryl, C₁₋₂₄alkyl or C₂₋₂₄alkenyl;

wherein R² is selected from the group comprising C₁₋₂₄alkyl, C₂₋₂₄alkenyl, C₆₋₁₀aryl, C₆₋₁₀aryl-C₁₋₆alkyl and C₁₋₆alkyl-C₆₋₁₀aryl, and wherein R² may be optionally substituted with one or more substituents each independently selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, —NO₂, heteroaryl (such as pyrrolyl), C₁₋₂₄alkyl, C₂₋₂₄alkenyl, C₆₋₁₀aryl, C₆₋₁₀aryl-C₁₋₆alkyl-C₆₋₁₀aryl, and halogen; preferably wherein R² is (optionally substituted) C₁₋₂₄alkyl or C₂₋₂₄alkenyl;

wherein R³ is selected from the group comprising C₁₋₂₄alkyl, C₂₋₂₄alkenyl, C₆₋₁₀aryl, C₆₋₁₀aryl-C₁₋₆alkyl and C₁₋₆alkyl-C₆₋₁₀aryl, and wherein R³ may be optionally substituted with one or more substituents each independently selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, —NO₂, heteroaryl (such as pyrrolyl), C₁₋₂₄alkyl, C₂₋₂₄alkenyl, C₆₋₁₀aryl, C₆₋₁₀aryl-C₁₋₆alkyl-C₆₋₁₀aryl, hydrogen, and halogen; preferably wherein R³ is (optionally substituted) C₁₋₂₄alkyl or C₂₋₂₄alkenyl;

wherein each R⁴ is independently C₁₋₆ alkyl, optionally substituted with one or more substituents each independently selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, —NO₂, heteroaryl (such as pyrrolyl), C₁₋₂₄alkyl, C₂₋₂₄alkenyl, C₆₋₁₀aryl, C₆₋₁₀aryl-C₁₋₆alkyl, C₁₋₆alkyl-C₆₋₁₀aryl, and halogen; preferably wherein R⁴ is (optionally substituted) C₁₋₂₄alkyl or C₂₋₂₄alkenyl;

wherein each R⁵ is independently selected from the group comprising C₁₋₂₄alkyl, C₂₋₂₄alkenyl, C₆₋₁₀aryl, C₆₋₁₀aryl-C₁₋₆alkyl and C₁₋₆alkyl-C₆₋₁₀aryl, and wherein R⁵ may be optionally substituted with one or more substituents each independently selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, —NO₂, heteroaryl (such as pyrrolyl), C₁₋₂₄alkyl, C₂₋₂₄alkenyl, C₆₋₁₀aryl, C₆₋₁₀aryl-C₁₋₆alkyl, C₁₋₆alkyl-C₆₋₁₀aryl, hydrogen, and halogen; preferably wherein R⁵ is (optionally substituted) C₁₋₂₄alkyl or C₂₋₂₄alkenyl;

wherein R⁶ is C₁₋₆alkyl, optionally substituted with one or more substituents each independently selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, —NO₂, heteroaryl (such as pyrrolyl), C₁₋₂₄alkyl, C₂₋₂₄alkenyl, C₆₋₁₀aryl, C₁₋₆alkyl-C₆₋₁₀aryl, and halogen;

wherein R⁷ is selected from the group comprising C₁₋₂₄alkyl, C₂₋₂₄alkenyl, C₆₋₁₀aryl, C₆₋₁₀aryl-C₁₋₆alkyl and C₁₋₆alkyl-C₆₋₁₀aryl, and wherein R⁷ may be optionally substituted with one or more substituents each independently selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, —NO₂, heteroaryl (such as pyrrolyl), C₁₋₂₄alkyl, C₂₋₂₄alkenyl, C₆₋₁₀aryl, C₆₋₁₀aryl-C₁₋₆alkyl-C₆₋₁₀aryl, and halogen; preferably wherein R⁷ is (optionally substituted) C₁₋₂₄alkyl or C₂₋₂₄alkenyl; and

wherein X⁻ is an organic or inorganic anion, preferably a halogen or tetrafluoroborate.

The present invention therefore also encompasses a process for preparing covalently grafted carbonaceous material, comprising the steps of:
(a) providing carbonaceous material, for example carbon nanotubes;
(b) providing at least one reactant;
(c) mixing the carbonaceous material with the reactant, thereby obtaining a mixture; and
(d) irradiating the mixture obtained in step (c) under IR radiation;

thereby obtaining covalently grafted carbonaceous material; wherein the reactant is selected from the group comprising: R¹—NH₂, R²—CH═CH₂, R³—Si(OR⁴)₃, (R⁵)₃—SiOR⁶, and R⁷—N⁺≡N X⁻, lactide, polylactide, preferably wherein the reactant is R¹—NH₂ or R⁷—N⁺≡N X;

wherein R¹ is selected from the group comprising C₆₋₁₀aryl, C₁₋₂₄ alkyl, C₂₋₂₄alkenyl, C₆₋₁₀aryl-C₁₋₆alkyl and C₁₋₆alkyl-C₆₋₁₀aryl, and wherein R¹ may be optionally substituted with one or more substituents each independently selected from the group comprising —OH, haloC₁₋₁₀alkyl, C(O)OH, —SH, —NO₂, heteroaryl, C₁₋₂₄ alkyl, C₂₋₂₄alkenyl, C₆₋₁₀aryl, C₆₋₁₀aryl-C₁₋₆alkyl, C₁₋₆alkyl-C₆₋₁₀aryl, and halogen;

wherein R² is selected from the group comprising C₁₋₂₄ alkyl, C₂₋₂₄alkenyl, C₆₋₁₀aryl, C₆₋₁₀aryl-C₁₋₆alkyl and C₁₋₆alkyl-C₆₋₁₀aryl, and wherein R² may be optionally substituted with one or more substituents each independently selected from the group comprising —OH, haloC₁₋₁₀alkyl, C(O)OH, —SH, —NO₂, heteroaryl, C₁₋₂₄ alkyl, C₂₋₂₄alkenyl, C₆₋₁₀aryl, C₆₋₁₀aryl-C₁₋₆alkyl, C₁₋₆alkyl-C₆₋₁₀aryl, and halogen;

wherein R³ is selected from the group comprising C₁₋₂₄ alkyl, C₂₋₂₄alkenyl, C₆₋₁₀aryl, C₆₋₁₀aryl-C₁₋₆alkyl and C₁₋₆alkyl-C₆₋₁₀aryl, and wherein R³ may be optionally substituted with one or more substituents each independently selected from the group comprising —OH, haloC₁₋₁₀alkyl, C(O)OH, —SH, —NO₂, heteroaryl, C₁₋₂₄ alkyl, C₂₋₂₄alkenyl, C₆₋₁₀aryl, C₆₋₁₀aryl-C₁₋₆alkyl, C₁₋₆alkyl-C₆₋₁₀aryl, hydrogen, and halogen;

wherein each R⁴ is independently C₁₋₆alkyl optionally substituted with one or more substituents each independently selected from the group comprising —OH, haloC₁₋₁₀alkyl, C(O)OH, —SH, —NO₂, heteroaryl, C₁₋₂₄ alkyl, C₂₋₂₄alkenyl, C₆₋₁₀aryl, C₆₋₁₀aryl-C₁₋₆alkyl, C₁₋₆alkyl-C₆₋₁₀aryl, and halogen;

wherein each R⁵ is independently selected from the group comprising: C₁₋₂₄ alkyl, C₂₋₂₄alkenyl, C₆₋₁₀aryl, C₆₋₁₀aryl-C₁₋₆alkyl and C₁₋₆alkyl-C₆₋₁₀aryl, and wherein R⁵ may be optionally substituted with one or more substituents each independently selected from the group comprising —OH, haloC₁₋₁₀alkyl, C(O)OH, —SH, —NO₂, heteroaryl, C₂₋₂₄alkenyl, C₆₋₁₀aryl, C₆₋₁₀aryl-C₁₋₆alkyl, C₁₋₆alkyl-C₆₋₁₀aryl, hydrogen, and halogen;

wherein R⁶ is C₁₋₆alkyl, and is optionally substituted with one or more substituents each independently selected from the group comprising —OH, haloC₁₋₁₀alkyl, C(O)OH, —SH, —NO₂, heteroaryl, C₂₋₂₄alkenyl, C₆₋₁₀aryl, C₆₋₁₀aryl-C₁₋₆alkyl, C₁₋₆alkyl-C₆₋₁₀aryl, and halogen;

wherein R⁷ is selected from the group comprising C₁₋₂₄ alkyl, C₂₋₂₄alkenyl, C₆₋₁₀aryl, C₆₋₁₀aryl-C₁₋₆alkyl and C₁₋₆alkyl-C₆₋₁₀aryl, and wherein R⁷ may be optionally substituted with one or more substituents each independently selected from the group comprising —OH, haloC₁₋₁₀alkyl, C(O)OH, —SH, —NO₂, heteroaryl, C₂₋₂₄alkenyl, C₆₋₁₀aryl, C₆₋₁₀aryl-C₁₋₆alkyl, C₁₋₆alkyl-C₆₋₁₀aryl, and halogen; and

wherein X⁻ is an organic or inorganic anion, preferably a halogen or tetrafluoroborate.

In an embodiment, the invention relates to a process for preparing covalently grafted carbonaceous material such as covalently grafted carbon nanotubes, comprising the steps of:
(a) providing carbon nanotubes;
(b) providing at least one reactant selected from the group comprising: R¹—NH₂, R²—CH═CH₂, R³—Si(OR⁴)₃, (R⁵)₃—SiOR⁶, and R⁷—N⁺≡N X⁻, lactide, polylactide, preferably wherein the reactant is R¹—NH₂ or R⁷—N⁺≡N X⁻, for example wherein the reactant is R¹—NH₂, for example wherein the reactant is R⁷—N⁺≡N X⁻; wherein R¹, R², R³, R⁴, R⁵, R⁶, R⁷ and X have the same meaning as that defined above;
(c) mixing the carbon nanotubes with the reactant, thereby obtaining a mixture; and
(d) irradiating the mixture obtained in step (c) under IR radiation;

thereby obtaining covalently grafted carbon nanotubes.

In a preferred embodiment, the reactant is selected from the group comprising: substituted aniline, aniline, diazonium salts, primary aliphatic amines, styrene, lactide, and polylactid acid (PLA). In some embodiments, the reactant is a lactide selected from the group comprising: L-lactide, D-lactide, enantiomeric lactide, preferably wherein the lactide is L-lactide.

In an embodiment, the invention relates to a process for preparing covalently grafted carbon nanotubes, comprising the steps of:
(a) providing carbon nanotubes;
(b) providing at least one reactant selected from the group comprising: selected from the group comprising: substituted aniline, aniline, diazonium salts, primary aliphatic amines, styrene, lactide, and polylactid acid;
(c) mixing the carbon nanotubes with the reactant, thereby obtaining a mixture; and
(d) irradiating the mixture obtained in step (c) under IR radiation;

thereby obtaining covalently grafted carbon nanotubes.

In a preferred embodiment, the reactant is a substituted aniline, preferably the reactant is a compound of formula (I):

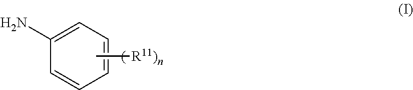

wherein each R¹¹ is independently hydrogen, halogen, or —NO₂, or is a group selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, heteroaryl (such as pyrrolyl, furanyl, thiophenyl, pyrazolyl, imidazolyl, oxazolyl, isoxazolyl, thiazolyl, isothiazolyl, triazolyl, oxadiazolyl, thiadiazolyl, tetrazolyl, oxatriazolyl, thiatriazolyl, pyridinyl, pyrimidyl, pyrazinyl, pyridazinyl, oxazinyl, dioxinyl, thiazinyl, triazinyl; preferably the heteroaryl is selected from pyrrolyl, furanyl, thiophenyl, pyrazolyl, imidazolyl, oxazolyl, isoxazolyl, triazolyl, oxadiazolyl, tetrazolyl, oxatriazolyl, pyridinyl, pyrimidyl, pyrazinyl, pyridazinyl, more preferably pyrrolyl, pyrazolyl, imidazolyl, pyridinyl, pyrimidyl, pyrazinyl, yet more preferably pyrrolyl), C₁₋₂₄alkyl, C₂₋₂₄alkenyl, C₆₋₁₀aryl, C₆₋₁₀aryl-C₁₋₆ alkyl, C₁₋₆alkyl-C₆₋₁₀aryl, each group being optionally substituted by one or more substituents each independently selected from halogen (for example fluorine), or C₁₋₆alkyl, wherein n is an integer selected from 1, 2, 3, 4 or 5, preferably 1, 2, or 3, yet more preferably 1 or 2.

For example, the reactant is a compound of formula (I):

wherein each R¹¹ is independently hydrogen, halogen, or —NO₂, or is a group selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), C(O)OH, —SH, heteroaryl (such as pyrrolyl, furanyl, thiophenyl, pyrazolyl, imidazolyl, oxazolyl, isoxazolyl, triazolyl, oxadiazolyl, tetrazolyl, oxatriazolyl, pyridinyl, pyrimidyl, pyrazinyl, pyridazinyl, more preferably pyrrolyl, pyrazolyl, imidazolyl, pyridinyl, pyrimidyl, pyrazinyl, yet more preferably pyrrolyl), C₁₋₂₄alkyl, each group being optionally substituted by one or more substituents each independently selected from halogen (for example fluorine), or C₁₋₆alkyl, wherein n is an integer selected from 1, 2, 3, 4 or 5, preferably 1, 2, or 3, yet more preferably 1 or 2.

For example, the reactant is a compound of formula (I):

wherein each R¹¹ is independently hydrogen, halogen, or —NO₂, or is a group selected from the group comprising —OH; CF₃—(CY₂)_{z}—, wherein Y is H or F and z is an integer selected from 0, 1, 2, 3, 4, 5, 6, 7, 8, or 9; C(O)OH; —SH; pyrrolyl; pyrazolyl; imidazolyl; pyridinyl; pyrimidyl; pyrazinyl (yet more preferably pyrrolyl), C₁₋₁₂alkyl, each group being optionally substituted by one or more substituents each independently selected from halogen (for example fluorine), or C₁₋₆alkyl, wherein n is an integer selected from 1, 2, 3, 4 or 5, preferably 1, 2, or 3, yet more preferably 1 or 2.

In a preferred embodiment, the reactant is a compound of formula (II) or (III), preferably of formula (II):

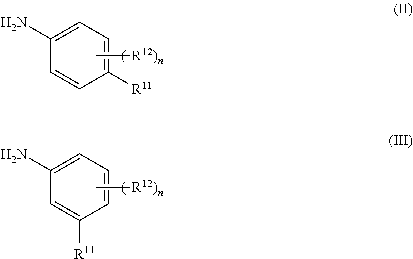

wherein R¹¹ is hydrogen, halogen, or —NO₂, or is a group selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9), —C(O)OH, —SH, heteroaryl (such as pyrrolyl, furanyl, thiophenyl, pyrazolyl, imidazolyl, oxazolyl, isoxazolyl, triazolyl, oxadiazolyl, tetrazolyl, oxatriazolyl, pyridinyl, pyrimidyl, pyrazinyl, pyridazinyl, more preferably pyrrolyl, pyrazolyl, imidazolyl, pyridinyl, pyrimidyl, pyrazinyl, yet more preferably pyrrolyl), C₁₋₂₄alkyl, C₂₋₂₄alkenyl, C₆₋₁₀aryl,

C₆₋₁₀aryl-C₁₋₆alkyl, C₁₋₆alkyl-C₆₋₁₀aryl, each group being optionally substituted by one or more substituents each independently selected from halogen (for example fluorine), or C₁₋₆alkyl,

each R¹² is independently hydrogen, halogen, or —NO₂, or is a group selected from the group comprising —OH, haloC₁₋₁₀alkyl (such as CF₃—(CY₂)_{z}—, wherein Y is H or F and z is an integer selected from 0, 1, 2, 3, 4, 5, 6, 7, 8, or 9;), —C(O)OH, —SH, heteroaryl (such as pyrrolyl, furanyl, thiophenyl, pyrazolyl, imidazolyl, oxazolyl, isoxazolyl, triazolyl, oxadiazolyl, tetrazolyl, oxatriazolyl, pyridinyl, pyrimidyl, pyrazinyl, pyridazinyl, more preferably pyrrolyl, pyrazolyl, imidazolyl, pyridinyl, pyrimidyl, pyrazinyl, yet more preferably pyrrolyl), C₁₋₂₄alkyl, C₂₋₂₄alkenyl, C₆₋₁₀aryl, C₆₋₁₀aryl-C₁₋₆alkyl, C₁₋₆ alkyl-C₆₋₁₀aryl, each group being optionally substituted by one or more substituents each independently selected from halogen (for example fluorine), or C₁₋₆alkyl, preferably each R¹² is independently hydrogen, halogen, haloC₁₋₁₀alkyl, or C₁₋₂₄alkyl, preferably R¹² is hydrogen,

and wherein n is an integer selected from 1, 2, 3, or 4, preferably 1, 2, or 3, yet more preferably 1 or 2; yet more preferably 1.

In an embodiment, the reactant is selected from the group comprising 4-hydroxyaniline, 3-hydroxyaniline, 4-trifluoromethylaniline, 3-trifluoromethylaniline, 4-carboxyaniline, 3-carboxyaniline, 4-aminothiphenol, 3-aminothiophenol, 4-nitroaniline, 3-nitroaniline, 4-(1H-pyrrol-1-yl)aniline, 4-(1H-pyrrol-2-yl)aniline, 4-(1H-pyrrol-3-yl)aniline, 3-(1H-pyrrol-1-yl)aniline, 3-(1H-pyrrol-2-yl)aniline, 3-(1H-pyrrol-3-yl)aniline, 4-tetradecylaniline, 3-tetradecylaniline, 3-tetradecylaniline, 4-(heptadecafluorooctyl)aniline, 3-(heptadecafluorooctyl)aniline.

In an embodiment, the invention relates to a process for preparing covalently grafted carbonaceous material, comprising the steps of:
(a) providing carbonaceous material;
(b) providing at least one reactant selected from the group comprising: selected from the group comprising: a compound of formula (I), (II) or (III), lactide, and polylactid acid;
(c) mixing the carbonaceous material with the reactant, thereby obtaining a mixture; and
(d) irradiating the mixture obtained in step (c) under IR radiation;

thereby obtaining covalently grafted carbonaceous material.

In an embodiment, the invention relates to a process for preparing covalently grafted carbon nanotubes, comprising the steps of:
(a) providing carbon nanotubes;
(b) providing at least one reactant selected from the group comprising: selected from the group comprising: a compound of formula (I), (II) or (III), lactide, and polylactid acid;
(c) mixing the carbon nanotubes with the reactant, thereby obtaining a mixture; and
(d) irradiating the mixture obtained in step (c) under IR radiation;

thereby obtaining covalently grafted carbon nanotubes.

In an embodiment, the reactant is present in an amount of at least 0.001 mol/g, compared to the weight of the carbonaceous material, preferably of at least 0.002 mol/g, preferably of at least 0.005 mol/g, preferably of at least 0.010 mol/g, preferably of at least 0.020 mol/g, preferably of at least 0.050 mol/g, for example of at least 0.100 mol/g.

In an embodiment, the reactant is present in an amount of at most 10.0 mol/g, compared to the weight of the carbonaceous material, preferably of at most 5.0 mol/g, preferably of at most 2.0 mol/g, preferably of at most 1.0 mol/g, preferably of at most 0.5 mol/g, for example of at most 0.2 mol/g.

In an embodiment, the reactant is present in an amount ranging from at least 0.001 mol/g to at most 10.0 mol/g, compared to the weight of the carbonaceous material; for example at least 0.01 mol/g to at most 1.0 mol/g, for example at least 0.01 mol/g to at most 0.50 mol/g, for example at least 0.1 mol/g to at most 0.30 mol/g.

In an embodiment, the invention relates to a process for preparing covalently grafted carbon nanotubes, comprising the steps of:
(a) providing carbon nanotubes;
(b) providing at least one reactant as described in any of the embodiments listed above, wherein reactant is present in an amount of at least 0.001 mol/g, compared to the weight of the carbonaceous material, preferably of at least 0.002 mol/g, preferably of at least 0.005 mol/g, preferably of at least 0.010 mol/g, preferably of at least 0.020 mol/g, preferably of at least 0.050 mol/g, for example of at least 0.100 mol/g;
(c) mixing the carbon nanotubes with the reactant, thereby obtaining a mixture; and
(d) irradiating the mixture obtained in step (c) under IR radiation;

thereby obtaining covalently grafted carbon nanotubes.

In an embodiment, the amount of reactant is normalized by the number of surface C atoms of the carbonaceous material, preferably by the number of surface C atoms of the CNTs. The number of surface C atoms of the CNTs can be measured as follows:

The average number of walls of CNTs is determined by High Resolution Transmission Electronic Microscopy. The mass of CNTs is determined by microbalance. Then the mass of surface C atoms is obtained by dividing the CNTs mass by the average number of walls. Then the number of surface C atoms is obtained by dividing the mass of surface C atoms by the atomic mass of C (12 g/mol). For example, for carbon nanotubes NC7000 commercially available from Nanocyl, assuming an average number of 10 walls and a mass of 1 g, the number of surface C atoms would be 0.008 mol.

In an embodiment, the amount of reactant is at least 1.0 eq./C, preferably at least 2.0 eq./C, preferably at least 3.0 eq./C, preferably at least 3.5 eq./C, preferably at least 3.8 eq./C, preferably at least 3.9 eq./C, preferably about 4.0 eq./C. In an embodiment, the amount of reactant is at most 10.0 eq./C, preferably at most 7.0 eq./C, preferably at most 5.0 eq./C, preferably at most 4.5 eq./C, preferably at most 4.2 eq./C, preferably at most 4.1 eq./C, preferably about 4.0 eq./C. In some embodiments, the amount of reactant is at least 1.0 eq./C and at most 10.0 eq./C, preferably at least 2.0 eq./C and at most 7.0 eq./C, preferably at least 3.0 eq./C and at most 5.0 eq./C, preferably at least 3.5 eq./C and at most 4.5 eq./C, preferably at least 3.8 eq./C and at most 4.2 eq./C, preferably at least 3.9 eq./C and at most 4.1 eq./C, preferably about 4.0 eq./C.

In an embodiment, the invention relates to a process for preparing covalently grafted carbon nanotubes, comprising the steps of:
(a) providing carbon nanotubes;
(b) providing at least one reactant as described in any of the embodiments listed above, wherein the amount of reactant is at least 1.0 eq./C, preferably at least 2.0 eq./C, preferably at least 3.0 eq./C, preferably at least 3.5 eq./C, preferably at least 3.8 eq./C, preferably at least 3.9 eq./C, preferably about 4.0 eq./C;
(c) mixing the carbon nanotubes with the reactant, thereby obtaining a mixture; and
(d) irradiating the mixture obtained in step (c) under IR radiation;

thereby obtaining covalently grafted carbon nanotubes.

In a preferred embodiment, step (c) further comprises mixing the carbonaceous material with a co-reactant, preferably wherein the co-reactant is a nitrite, preferably wherein the co-reactant is sodium nitrite or isoamyl nitrite. Preferably, the co-reactant activates the reactant, for example by forming a diazonium salt.

In an embodiment, the invention relates to a process for preparing covalently grafted carbon nanotubes, comprising the steps of:
(a) providing carbon nanotubes;
(b) providing at least one reactant as described in any of the embodiments listed above;
(c) mixing the carbon nanotubes with the reactant, thereby obtaining a mixture; and
(d) irradiating the mixture obtained in step (c) under IR radiation;

thereby obtaining covalently grafted carbon nanotubes, wherein step (c) further comprises mixing the carbon nanotubes with at least one co-reactant, preferably wherein the co-reactant is a nitrite, preferably wherein the co-reactant is sodium nitrite or isoamyl nitrite.

In an embodiment, the co-reactant is present in an amount of at least 0.001 mol/g, compared to the weight of the carbonaceous material, preferably of at least 0.002 mol/g, preferably of at least 0.005 mol/g, preferably of at least 0.010 mol/g, preferably of at least 0.020 mol/g, preferably of at least 0.050 mol/g, preferably of at least 0.100 mol/g.

In an embodiment, the co-reactant is present in an amount of at most 10.0 mol/g, compared to the weight of the carbonaceous material, preferably of at most 5.0 mol/g, preferably of at most 2.0 mol/g, preferably of at most 1.0 mol/g, preferably of at most 0.5 mol/g, for example of at most 0.2 mol/g.

In an embodiment, the co-reactant is present in an amount ranging from at least 0.001 mol/g to at most 10.0 mol/g, compared to the weight of the carbonaceous material; for example at least 0.01 mol/g to at most 1.0 mol/g, for example at least 0.01 mol/g to at most 0.50 mol/g, for example at least 0.01 mol/g to at most 0.30 mol/g.

In an embodiment, the ratio of the amount of co-reactant (expressed in mole) to the amount of reactant (expressed in mole) is at least 0.01, preferably at least 0.02, preferably at least 0.05, preferably at least 0.10, preferably at least 0.20, preferably at least 0.50, preferably about 1.00.

In an embodiment, the ratio of the amount of co-reactant (expressed in mole) to the amount of reactant (expressed in mole) is at most 100.0, preferably at most 50.0, preferably at most 20.0, preferably at most 10.0, preferably at most 5.0, preferably at most 2.0, preferably about 1.0.

In an embodiment, the ratio of the amount of co-reactant (expressed in mole) to the amount of reactant (expressed in mole) is ranging from at least 0.01 to at most 100.0; for example at least 0.10 to at most 50.0, for example at least 0.10 to at most 20.0, for example at least 0.10 to at most 15.0 mol.

In an embodiment, the amount of co-reactant is normalized by the number of surface C atoms of the carbonaceous material, preferably by the number of surface C atoms of the CNTs. The number of surface C atoms of the CNTs can be measured as described above.

In an embodiment, the amount of co-reactant is at least 1.0 eq./C, preferably at least 2.0 eq./C, preferably at least 3.0 eq./C, preferably at least 3.5 eq./C, preferably at least 3.8 eq./C, preferably at least 3.9 eq./C, preferably at least 4.0 eq./C, preferably about 4.1 eq./C. In an embodiment, the amount of co-reactant is at most 10.0 eq./C, preferably at most 7.0 eq./C, preferably at most 5.0 eq./C, preferably at most 4.5 eq./C, preferably at most 4.3 eq./C, preferably at most 4.2 eq./C, preferably about 4.1 eq./C. In some embodiments, the amount of co-reactant is at least 1.0 eq./C and at most 10.0 eq./C, preferably at least 2.0 eq./C and at most 7.0 eq./C, preferably at least 3.0 eq./C and at most 5.0 eq./C, preferably at least 3.5 eq./C and at most 4.5 eq./C, preferably at least 3.8 eq./C and at most 4.2 eq./C, preferably at least 3.9 eq./C and at most 4.1 eq./C, preferably about 4.0 eq./C.

In an embodiment, the reactant is a diazonium salt, and no co-reactant is used.

In a preferred embodiment, step (c) further comprises mixing the carbonaceous material with liquid or gaseous solvent, preferably with a liquid solvent.

In an embodiment, the invention relates to a process for preparing covalently grafted carbonaceous material, comprising the steps of:
(a) providing carbonaceous material;
(b) providing at least one reactant as described in any of the embodiments listed above;
(c1) mixing the carbonaceous material with the reactant, thereby obtaining a mixture;
(c2) optionally mixing the carbonaceous material with at least one co-reactant, preferably wherein the co-reactant is a nitrite, preferably wherein the co-reactant is sodium nitrite or isoamyl nitrite;
(c3) mixing the carbonaceous material with liquid or gaseous solvent, preferably with a liquid solvent and wherein step; and
(d) irradiating the mixture obtained in step (c) under IR radiation;

thereby obtaining covalently grafted carbonaceous material.

In an embodiment, the invention relates to a process for preparing covalently grafted carbon nanotubes, comprising the steps of:
(a) providing carbon nanotubes;
(b) providing at least one reactant as described in any of the embodiments listed above;
(c1) mixing the carbon nanotubes with the reactant, thereby obtaining a mixture;
(c2) optionally mixing the carbon nanotubes with at least one co-reactant, preferably wherein the co-reactant is a nitrite, preferably wherein the co-reactant is sodium nitrite or isoamyl nitrite;
(c3) mixing the carbon nanotubes with liquid or gaseous solvent, preferably with a liquid solvent and wherein step; and
(d) irradiating the mixture obtained in step (c) under IR radiation;

thereby obtaining covalently grafted carbon nanotubes.

In an embodiment, the invention relates to a process for preparing covalently grafted carbon nanotubes, comprising the steps of:
(a) providing carbon nanotubes;
(b) providing at least one reactant as described in any of the embodiments listed above;
(c1) mixing the carbon nanotubes with the reactant, thereby obtaining a mixture;
(c2) mixing the carbon nanotubes with at least one co-reactant, preferably wherein the co-reactant is a nitrite, preferably wherein the co-reactant is sodium nitrite or isoamyl nitrite;
(c3) mixing the carbon nanotubes with liquid or gaseous solvent, preferably with a liquid solvent; and
(d) irradiating the mixture obtained in step (c) under IR radiation;

thereby obtaining covalently grafted carbon nanotubes.

In a preferred embodiment, the solvent is selected from the group comprising: water, acetonitrile, ethanol, pyridine, aliphatic hydrocarbons, aromatic hydrocarbons, nitrogen, argon, and helium. Preferably the solvent is selected from the group comprising: water, acetonitrile, ethanol, and pyridine. More preferably the solvent is water. Preferably, the water is distillated water.

In an embodiment, the solvent is a gaseous solvent, for example selected from the group comprising: N2, Ar, He.

In an embodiment, the solvent is present in an amount of at least 0.01 l/g, compared to the weight of the carbonaceous material, preferably of at least 0.02 l/g, preferably of at least 0.05 l/g, preferably of at least 0.1 l/g, preferably of at least 0.2 l/g, preferably of at least 0.5 l/g, preferably of at least 0.8 l/g, preferably of at least 0.9 l/g, for example about 1.0 l/g.

In an embodiment, the solvent is present in an amount of at most 100 l/g, compared to the weight of the carbonaceous material, preferably of at most 50 l/g, preferably of at most 20 l/g, preferably of at most 10 l/g, preferably of at most 5 l/g, preferably of at most 2 l/g, preferably of at most 1.5 l/g, preferably of at most 1.2 l/g, preferably of at most 1.1 l/g, for example about 1.0 l/g.

In an embodiment, the solvent is present in an amount ranging from at least 0.01 l/g to at most 100.0 l/g, compared to the weight of the carbonaceous material; for example at least 0.02 l/g to at most 20.0 l/g, for example at least 0.1 l/g to at most 10.0 l/g, for example at least 0.1 l/g to at most 3.0 l/g.

In a preferred embodiment, step (c) further comprises mixing the carbonaceous material with liquid or gaseous co-solvent, preferably with a liquid co-solvent, preferably wherein the co-solvent is an organic or inorganic acid, more preferably wherein the co-solvent is selected from perchloric acid, hydrochloric acid and sodium hydroxide, for example wherein the co-solvent is selected from perchloric acid and hydrochloric acid.

In an embodiment, the invention relates to a process for preparing covalently grafted carbonaceous material, comprising the steps of:
(a) providing carbonaceous material;
(b) providing at least one reactant as described in any of the embodiments listed above;
(c1) mixing the carbonaceous material with the reactant, thereby obtaining a mixture;
(c2) optionally mixing the carbonaceous material with at least one co-reactant, preferably wherein the co-reactant is a nitrite, preferably wherein the co-reactant is sodium nitrite or isoamyl nitrite;
(c3) optionally mixing the carbonaceous material with liquid or gaseous solvent, preferably with a liquid solvent, preferably wherein the solvent is selected from the group comprising: water, acetonitrile, ethanol, pyridine, aliphatic hydrocarbons, aromatic hydrocarbons, nitrogen, argon, and helium; more preferably the solvent is selected from the group comprising: water, acetonitrile, ethanol, and pyridine; yet more preferably water;
(c4) mixing the carbonaceous material with liquid or gaseous co-solvent, preferably with a liquid co-solvent, preferably wherein the co-solvent is an organic or inorganic acid, more preferably wherein the co-solvent is selected from perchloric acid, hydrochloric acid and sodium hydroxide, for example wherein the co-solvent is selected from perchloric acid and hydrochloric acid; and
(d) irradiating the mixture obtained in step (c) under IR radiation;

thereby obtaining covalently grafted carbonaceous material.

In an embodiment, the invention relates to a process for preparing covalently grafted carbon nanotubes, comprising the steps of:
(a) providing carbon nanotubes;
(b) providing at least one reactant as described in any of the embodiments listed above;
(c1) mixing the carbon nanotubes with the reactant, thereby obtaining a mixture;
(c2) optionally mixing the carbon nanotubes with at least one co-reactant, preferably wherein the co-reactant is a nitrite, preferably wherein the co-reactant is sodium nitrite or isoamyl nitrite;
(c3) optionally mixing the carbon nanotubes with liquid or gaseous solvent, preferably with a liquid solvent; preferably wherein the solvent is selected from the group comprising: water, acetonitrile, ethanol, pyridine, aliphatic hydrocarbons, aromatic hydrocarbons, nitrogen, argon, and helium; more preferably the solvent is selected from the group comprising: water, acetonitrile, ethanol, and pyridine; yet more preferably water;
(c4) mixing the carbon nanotubes with liquid or gaseous co-solvent, preferably with a liquid co-solvent, preferably wherein the co-solvent is an organic or inorganic acid, more preferably wherein the co-solvent is selected from perchloric acid, hydrochloric acid and sodium hydroxide, for example wherein the co-solvent is selected from perchloric acid and hydrochloric acid; and
(d) irradiating the mixture obtained in step (c) under IR radiation;

thereby obtaining covalently grafted carbon nanotubes.

In an embodiment, the co-solvent is present in an amount of at least 0.0001 mol/g, compared to the weight of the carbonaceous material, preferably of at least 0.0002 mol/g, preferably of at least 0.0005 mol/g, preferably of at least 0.0010 mol/g, preferably of at least 0.0020 mol/g, preferably of at least 0.0050 mol/g, preferably of at least 0.0100 mol/g, preferably of at least 0.0200 mol/g, preferably of at least 0.0500 mol/g, preferably of at least 0.1000 mol/g.

In an embodiment, the co-solvent is present in an amount of at most 10.0 mol/g, compared to the weight of the carbonaceous material, preferably of at most 5.0 mol/g, preferably of at most 2.0 mol/g, preferably of at most 1.0 mol/g, preferably of at most 0.5 mol/g, preferably of at most 0.2 mol/g.

In an embodiment, the co-solvent is present in an amount ranging from at least 0.0010 mol/g to at most 10.0 mol/g, compared to the weight of the carbonaceous material; for example at least 0.0020 mol/g to at most 5.0 mol/g, for example at least 0.0030 mol/g to at most 1.0 mol/g, for example at least 0.0030 mol/g to at most 0.50 mol/g.

In an embodiment, the ratio of the amount of co-solvent (expressed in mole) to the amount of reactant (expressed in mole) is at least 0.01, preferably at least 0.02, preferably at least 0.05, preferably at least 0.10, preferably at least 0.20, preferably at least 0.50, preferably at least 0.80, preferably at least 0.90, preferably about 1.00.

In an embodiment, the ratio of the amount of co-solvent (expressed in mole) to the amount of reactant (expressed in mole) is at most 100.0, preferably at most 50.0, preferably at most 20.0, preferably at most 10.0, preferably at most 5.0, preferably at most 2.0, preferably at most 1.5, preferably at most 1.2, preferably at most 1.1, preferably about 1.0.

In an embodiment, the ratio of the amount of co-solvent (expressed in mole) to the amount of reactant (expressed in mole) is ranging from at least 0.0010 to at most 100.0; for example at least 0.010 to at most 50.0, for example at least 0.010 to at most 30.0, for example at least 0.010 to at most 20.0 mol.

In some embodiments, the carbonaceous material is oxidized prior to mixing with the reactant, for example with HNO₃ or a mixture of H₂SO₄ and HNO₃. In some embodiments, the carbonaceous material is oxidized with H₂SO₄, preferably wherein the H₂SO₄ provided as a solution of at least 90%, preferably of at least 95%, preferably of at least 98%. In some embodiments, the carbonaceous material is oxidized with HNO₃, preferably wherein the HNO₃ provided as a solution of at least 50%, preferably of at least 60%, preferably of at least 70%.

In an embodiment, step (c) further comprises mixing the carbonaceous material with an acid precursor, preferably wherein the acid precursor is HClO₄.

In an embodiment, the amount of acid precursor is normalized by the number of surface C atoms of the carbonaceous material, preferably by the number of surface C atoms of the CNTs.

The number of surface C atoms of the CNTs can be measured as described above.

In an embodiment, the amount of acid precursor is at least 1.0 eq./C, preferably at least 2.0 eq./C, preferably at least 3.0 eq./C, preferably at least 3.5 eq./C, preferably at least 3.8 eq./C, preferably at least 3.9 eq./C, preferably at least 4.0 eq./C, preferably about 4.1 eq./C. In an embodiment, the amount of acid precursor is at most 10.0 eq./C, preferably at most 7.0 eq./C, preferably at most 5.0 eq./C, preferably at most 4.5 eq./C, preferably at most 4.3 eq./C, preferably at most 4.2 eq./C, preferably about 4.1 eq./C.

In an embodiment, the process is performed at room temperature. In an embodiment, the process is performed at atmospheric pressure. In an embodiment, the process is performed at room temperature and at atmospheric pressure. In an embodiment, the temperature is at most the boiling temperature of the solvent. In an embodiment, the pressure is at most the maximum pressure of the vessel wherein the process is carried out.

In a preferred embodiment, the IR radiation has a wavelength of at least 0.75 μm. In a preferred embodiment the IR radiation has a wavelength of at most 3.00 μm. For example, the IR radiation has a wavelength of at least 0.75 μm and at most 3.00 μm; for example, least 1.00 μm and at most 2.00 μm, preferably of about 1.50 μm.

In an embodiment, the invention relates to a process for preparing covalently grafted carbonaceous material, comprising the steps of:
(a) providing carbonaceous material;
(b) providing at least one reactant as described in any of the embodiments listed above;
(c1) mixing the carbonaceous material with the reactant, thereby obtaining a mixture;
(c2) optionally mixing the carbonaceous material with at least one co-reactant, preferably wherein the co-reactant is a nitrite, preferably wherein the co-reactant is sodium nitrite or isoamyl nitrite;
(c3) optionally mixing the carbonaceous material with liquid or gaseous solvent, preferably with a liquid solvent, preferably wherein the solvent is selected from the group comprising: water, acetonitrile, ethanol, pyridine, aliphatic hydrocarbons, aromatic hydrocarbons, nitrogen, argon, and helium; more preferably the solvent is selected from the group comprising: water, acetonitrile, ethanol, and pyridine; yet more preferably water;
(c4) optionally mixing the carbonaceous material with liquid or gaseous co-solvent, preferably with a liquid co-solvent, preferably wherein the co-solvent is an organic or inorganic acid, more preferably wherein the co-solvent is selected from perchloric acid, hydrochloric acid and sodium hydroxide, for example wherein the co-solvent is selected from perchloric acid and hydrochloric acid; and
(d) irradiating the mixture obtained in step (c) under IR radiation; wherein the IR radiation has a wavelength of at least 0.75 μm; preferably the IR radiation has a wavelength of at most 3.00 μm; for example, least 1.00 μm and at most 2.00 μm, preferably of about 1.50 μm;

thereby obtaining covalently grafted carbonaceous material.

In an embodiment, the invention relates to a process for preparing covalently grafted carbon nanotubes, comprising the steps of:
(a) providing carbon nanotubes;
(b) providing at least one reactant as described in any of the embodiments listed above;
(c1) mixing the carbon nanotubes with the reactant, thereby obtaining a mixture;
(c2) optionally mixing the carbon nanotubes with at least one co-reactant, preferably wherein the co-reactant is a nitrite, preferably wherein the co-reactant is sodium nitrite or isoamyl nitrite;
(c3) optionally mixing the carbon nanotubes with liquid or gaseous solvent, preferably with a liquid solvent, preferably wherein the solvent is selected from the group comprising: water, acetonitrile, ethanol, pyridine, aliphatic hydrocarbons, aromatic hydrocarbons, nitrogen, argon, and helium; more preferably the solvent is selected from the group comprising: water, acetonitrile, ethanol, and pyridine; yet more preferably water;
(c4) optionally mixing the carbon nanotubes with liquid or gaseous co-solvent, preferably with a liquid co-solvent, preferably wherein the co-solvent is an organic or inorganic acid, more preferably wherein the co-solvent is selected from perchloric acid, hydrochloric acid and sodium hydroxide, for example wherein the co-solvent is selected from perchloric acid and hydrochloric acid; and
(d) irradiating the mixture obtained in step (c) under IR radiation; wherein the IR radiation has a wavelength of at least 0.75 μm; preferably the IR radiation has a wavelength of at most 3.00 μm; for example, least 1.00 μm and at most 2.00 μm, preferably of about 1.50 μm;

thereby obtaining covalently grafted carbon nanotubes.

In a preferred embodiment, step (d) lasts for at most 240 minutes, preferably for at most 180 minutes, preferably for at most 120 minutes. In an embodiment, step (d) lasts for at least 10 minutes, preferably for at least 20 minutes, preferably for at least 40 minutes. In an embodiment, step (d) lasts for at least 10 minutes and at most 240 minutes, preferably for at least 20 minutes and at most 180 minutes, preferably for at least 40 minutes and at most 120 minutes, for example for about 60 minutes.

In an embodiment, the IR radiation has a power of at least 1 W, preferably of at least 2 W, preferably of at least 5 W, preferably of at least 10 W, preferably of at least 20 W, preferably of at least 50 W, preferably of at least 100 W. In an embodiment, the IR radiation has a power of at most 10 000 W, preferably of at most 5 000 W, preferably of at most 2 000 W, preferably of at most 1 000 W, preferably of at most 500 W, preferably of at most 200 W. In an embodiment, the IR radiation has a power of at least 2 W and at most 10 000 W, preferably of at least 5 W and at most 5 000 W, preferably of at least 10 W and at most 2 000 W, preferably of at least 20 W and at most 1 000 W, preferably of at least 50 W and at most 500 W, preferably of at least 100 W and at most 200 W.

According to a second aspect, the invention provides a process for preparing a polymeric composite, comprising the steps of:
(a) providing a polymer composition comprising at least one polymer; preferably comprising at least one polyolefin, preferably comprising polyethylene or polypropylene;
(b) preparing at least 0.001% by weight of covalently grafted carbonaceous material according to the process of the invention, relative to the total weight of the polymeric composite; and
(c) blending the covalently grafted carbonaceous material with the polymer composition, thereby obtaining a polymeric composite.

Suitable blends for the polymeric composite according to the invention may be physical blends or chemical blends. In a preferred embodiment, the polymeric composite is a nanocomposite. As used herein, the term “nanocomposite” is used to denote a blend of nanoparticles and one or more polymers, preferably one or more polyolefins. The nanocomposite according to the invention comprises at least one polymer composition and covalently grafted carbonaceous nanoparticles.

The polymeric composition according to the invention comprises at least 0.001% by weight of covalently grafted carbonaceous material (preferably covalently grafted carbonaceous nanoparticles, more preferably covalently grafted carbon nanotubes), relative to the total weight of the polymeric composition. For example, the polymeric composition of the present invention can comprise at least 0.005% by weight, more preferably at least 0.01% by weight and most preferably at least 0.05% by weight, relative to the total weight of the polymeric composition, of covalently grafted carbonaceous material, preferably covalently grafted carbonaceous nanoparticles.

In some embodiments of the invention, the polymeric composition comprises from 0.001% to 25% by weight of covalently grafted carbonaceous material, preferably covalently grafted carbonaceous nanoparticles, preferably from 0.002% to 20% by weight, preferably from 0.005% to 10% by weight, preferably from 0.01% to 5% by weight, relative to the total weight of the polymeric composition.

Preferably, the polymeric composition of the present invention comprises at most 20% by weight, more preferably at most 15% by weight, even more preferably at most 10% by weight, and most preferably at most 5% by weight, relative to the total weight of the polymeric composition, of covalently grafted carbonaceous material, preferably covalently grafted carbonaceous nanoparticles.

The polymeric composite according to the invention comprises at least one polymer composition. The polymer composition according to the invention comprises one or more polymers.

In an embodiment of the invention, the polymeric composite comprises at least 50% by weight of polymer based on the total weight of the polymeric composite. In a preferred embodiment of the invention, the polymeric composite comprises at least 80% by weight of polymer based on the total weight of the polymeric composite. In a more preferred embodiment of the invention, the polymeric composite comprises at least 90% by weight of polymer based on the total weight of the polymeric composite.

The polymer compositions suitable for use in the present invention are not particularly limited. However, it is preferred that the polymer composition comprises at least 50% by weight, more preferably at least 70% by weight or 90% by weight, even more preferably at least 95% by weight or 97% by weight, still even more preferably at least 99% by weight or 99.5% by weight or 99.9% by weight, relative to its total weight, of a polymer selected from the group comprising polyolefins, polyamides, poly(hydroxy carboxylic acid), polystyrene, polyesters or blends of these. Most preferably, the polymer composition comprises a polymer selected from the group comprising polyolefins, polylactic acid, polystyrene, polyethylene terephthalate, polyurethane, and blends thereof.

The most preferred polymers are polyolefins, preferably polyethylene and polypropylene. In a preferred embodiment, the polymer composition comprises at least one polyolefin. As used herein, the terms “olefin polymer” and “polyolefin” are used interchangeably.

In an embodiment, the polymeric composite according to the invention comprises at least one polyolefin composition.

In an embodiment of the invention, the polymeric composition comprises at least 50% by weight of polyolefin based on the total weight of the polymeric composition. In a preferred embodiment of the invention, the polymeric composition comprises at least 80% by weight of polyolefin based on the total weight of the polymeric composition. In a more preferred embodiment of the invention, the polymeric composition comprises at least 90% by weight of polyolefin based on the total weight of the polymeric composition.

The polyolefins used in the present invention may be any olefin homopolymer or any copolymer of an olefin and one or more comonomers. The polyolefins may be atactic, syndiotactic or isotactic. The olefin can for example be ethylene, propylene, 1-butene, 1-pentene, 1-hexene, 4-methyl-1-pentene or 1-octene, but also cycloolefins such as for example cyclopentene, cyclohexene, cyclooctene or norbornene. The comonomer is different from the olefin and chosen such that it is suited for copolymerization with the olefin. The comonomer may also be an olefin as defined above. Further examples of suitable comonomers are vinyl acetate (H₃C—C(═O)O—CH═CH₂) or vinyl alcohol (“HO—CH═CH₂”, which as such is not stable and tends to polymerize). Examples of olefin copolymers suited for use in the present invention are random copolymers of propylene and ethylene, random copolymers of propylene and 1-butene, heterophasic copolymers of propylene and ethylene, ethylene-butene copolymers, ethylene-hexene copolymers, ethylene-octene copolymers, copolymers of ethylene and vinyl acetate (EVA), copolymers of ethylene and vinyl alcohol (EVOH).

Most preferred polyolefins for use in the present invention are olefin homopolymers and copolymers of an olefin and one or more comonomers, wherein said olefin and said one or more comonomer is different, and wherein said olefin is ethylene or propylene. The term “comonomer” refers to olefin comonomers which are suitable for being polymerized with olefin monomers, preferably ethylene or propylene monomers. Comonomers may comprise but are not limited to aliphatic C₂-C₂₀ alpha-olefins. Examples of suitable aliphatic C₂-C₂₀ alpha-olefins include ethylene, propylene, 1-butene, 4-methyl-1-pentene, 1-hexene, 1-octene, 1-decene, 1-dodecene, 1-tetradecene, 1-hexadecene, 1-octadecene and 1-eicosene. In an embodiment, the comonomer is vinyl acetate.

As used herein, the term “co-polymer” refers to a polymer, which is made by linking two different types of monomers in the same polymer chain. As used herein, the term “homopolymer” refers to a polymer which is made by linking olefin (preferably ethylene) monomers, in the absence of comonomers. The amount of comonomer can be from 0 to 12% by weight, based on the weight of the polyolefin, more preferably it can be from 0 to 9% by weight and most preferably it can be from 0 to 7% by weight. A copolymer can be a random or block (heterophasic) copolymer. Preferably, the copolymer is a random copolymer. Such olefin homopolymer and copolymers of an olefin and one or more comonomers are non-polar polymers. Preferred polyolefins for use in the present invention are propylene and ethylene polymers. Preferably, the polyolefin is selected from polyethylene and polypropylene homo- and copolymers. Preferably, the polyolefin is polyethylene or polypropylene, or a copolymer thereof. Preferably, the polyolefin is polyethylene.

In a preferred embodiment of the invention, the polyolefin composition comprises at least 50% by weight of polyolefin, relative to the total weight of the polyolefin composition. Preferably, the polyolefin composition comprises at least 60% by weight of polyolefin, preferably at least 70% by weight of polyolefin, preferably at least 80% by weight of polyolefin, preferably at least 90% by weight of polyolefin, preferably at least 95% by weight of polyolefin, preferably at least 99% by weight of polyolefin, relative to the total weight of the polyolefin composition. In a preferred embodiment of the invention, the polyolefin composition comprises at least 50% by weight of polyethylene, relative to the total weight of the polyolefin composition. Preferably, the polyolefin composition comprises at least 60% by weight of polyethylene, preferably at least 70% by weight of polyethylene, preferably at least 80% by weight of polyethylene, preferably at least 90% by weight of polyethylene, for example at least 95% by weight of polyethylene, for example at least 99% by weight of polyethylene, relative to the total weight of the polyolefin composition.

The polyolefin composition according to the invention may have a monomodal or multimodal molecular weight distribution, for example a bimodal molecular weight distribution.

By the term “monomodal polyolefin” or “polyolefin with a monomodal molecular weight distribution” it is meant, polyolefins having one maxima in their molecular weight distribution curve defined also as unimodal distribution curve. By the term “polyolefin with a bimodal molecular weight distribution” or “bimodal polyolefin” it is meant, polyolefins having a distribution curve being the sum of two unimodal molecular weight distribution curves. The term “multimodal” refers to the “multimodal molecular weight distribution” of a polyolefin, having two or more distinct but possibly overlapping populations of polyolefin macromolecules each having different weight average molecular weights. By the term “polyolefin with a multimodal molecular weight distribution” or “multimodal” polyolefin it is meant polyolefin with a distribution curve being the sum of at least two, preferably more than two unimodal distribution curves.

The bimodal or multimodal polyolefin composition may be a physical blend or a chemical blend of two or more monomodal polyolefins.

The polyolefin, such as polyethylene, can be prepared in the presence of any catalyst known in the art. As used herein, the term “catalyst” refers to a substance that causes a change in the rate of a polymerization reaction without itself being consumed in the reaction. In the present invention, it is especially applicable to catalysts suitable for the polymerization of ethylene to polyethylene. These catalysts will be referred to as ethylene polymerization catalysts or polymerization catalysts. Suitable catalysts are well known in the art. Examples of suitable catalysts include but are not limited to chromium oxide such as those supported on silica, organometal catalysts including those known in the art as “Ziegler” or “Ziegler-Natta” catalysts, metallocene catalysts and the like. The term “co-catalyst” as used herein refers to materials that can be used in conjunction with a catalyst in order to improve the activity of the catalyst during the polymerization process.

The term “chromium catalysts” refers to catalysts obtained by deposition of chromium oxide on a support, e.g. a silica or aluminum support. Illustrative examples of chromium catalysts comprise but are not limited to CrSiO₂ or CrAl₂O₃.

The term “Ziegler-Natta catalyst” or “ZN catalyst” refers to catalysts having a general formula M¹Xᵥ, wherein M¹ is a transition metal compound selected from group IV to VII from the periodic table of elements, wherein X is a halogen, and wherein v is the valence of the metal. Preferably, M¹ is a group IV, group V or group VI metal, more preferably titanium, chromium or vanadium and most preferably titanium. Preferably, X is chlorine or bromine, and most preferably, chlorine. Illustrative examples of the transition metal compounds comprise but are not limited to TiCl₃ and TiCl₄. Suitable ZN catalysts for use in the invention are described in U.S. Pat. No. 6,930,071 and U.S. Pat. No. 6,864,207, which are incorporated herein by reference.

The term “metallocene catalyst” is used herein to describe any transition metal complexes consisting of metal atoms bonded to one or more ligands. The metallocene catalysts are compounds of Group 4 transition metals of the Periodic Table such as titanium, zirconium, hafnium, etc., and have a coordinated structure with a metal compound and ligands composed of one or two groups of cyclo-pentadienyl, indenyl, fluorenyl or their derivatives. Use of metallocene catalysts in the polymerization of polyethylene has various advantages. The key to metallocenes is the structure of the complex. The structure and geometry of the metallocene can be varied to adapt to the specific need of the producer depending on the desired polymer. Metallocenes comprise a single metal site, which allows for more control of branching and molecular weight distribution of the polymer. Monomers are inserted between the metal and the growing chain of polymer.

In an embodiment, the metallocene catalyst has a general formula (I) or (II):

(Ar)₂MQ₂ (I); or

R¹⁰¹(Ar)₂MQ₂ (II)

wherein the metallocenes according to formula (I) are non-bridged metallocenes and the metallocenes according to formula (II) are bridged metallocenes;

wherein said metallocene according to formula (I) or (II) has two Ar bound to M which can be the same or different from each other;

wherein Ar is an aromatic ring, group or moiety and wherein each Ar is independently selected from the group consisting of cyclopentadienyl, indenyl, tetrahydroindenyl or fluorenyl, wherein each of said groups may be optionally substituted with one or more substituents each independently selected from the group consisting of halogens, a hydrosilyl, a SiR¹⁰²₃ group wherein R¹⁰² is a hydrocarbyl having 1 to 20 carbon atoms, and a hydrocarbyl having 1 to 20 carbon atoms, wherein said hydrocarbyl optionally contains one or more atoms selected from the group comprising B, Si, S, O, F, Cl and P;

wherein M is a transition metal selected from the group consisting of titanium, zirconium, hafnium and vanadium; and preferably is zirconium;

wherein each Q is independently selected from the group consisting of halogens; a hydrocarboxy having 1 to 20 carbon atoms; and a hydrocarbyl having 1 to 20 carbon atoms,

wherein said hydrocarbyl optionally contains one or more atoms selected from the group comprising B, Si, S, O, F, Cl and P; and

wherein R¹⁰¹ is a divalent group or moiety bridging the two Ar groups and selected from the group consisting of a C₁-C₂₀ alkylene, a germanium, a silicon, a siloxane, an alkylphosphine and an amine, and wherein said R¹⁰¹ is optionally substituted with one or more substituents each independently selected from the group consisting of halogens, a hydrosilyl, a SiR¹⁰³₃ group wherein R¹⁰³ is a hydrocarbyl having 1 to 20 carbon atoms, and a hydrocarbyl having 1 to 20 carbon atoms, wherein said hydrocarbyl optionally contains one or more atoms selected from the group comprising B, Si, S, O, F, Cl and P.

Illustrative examples of metallocene catalysts comprise but are not limited to bis(cyclopentadienyl) zirconium dichloride (Cp₂ZrCl₂), bis(cyclopentadienyl) titanium dichloride (Cp₂TiCl₂), bis(cyclopentadienyl) hafnium dichloride (Cp₂HfCl₂); bis(tetrahydroindenyl) zirconium dichloride, bis(indenyl) zirconium dichloride, and bis(n-butyl-cyclopentadienyl) zirconium dichloride, ethylenebis(4,5,6,7-tetrahydro-1-indenyl) zirconium dichloride, ethylenebis(1-indenyl) zirconium dichloride, dimethylsilylene bis(2-methyl-4-phenyl-inden-1-yl) zirconium dichloride, diphenylmethylene (cyclopentadienyl)(fluoren-9-yl) zirconium dichloride, and dimethylmethylene[1-(4-tert-butyl-2-methyl-cyclopentadienyl)](fluoren-9-yl) zirconium dichloride.

The metallocene catalysts can be provided on a solid support. The support can be an inert solid, organic or inorganic, which is chemically unreactive with any of the components of the conventional metallocene catalyst. Suitable support materials for the supported catalyst of the present invention include solid inorganic oxides, such as silica, alumina, magnesium oxide, titanium oxide, thorium oxide, as well as mixed oxides of silica and one or more Group 2 or 13 metal oxides, such as silica-magnesia and silica-alumina mixed oxides. Silica, alumina, and mixed oxides of silica and one or more Group 2 or 13 metal oxides are preferred support materials. Preferred examples of such mixed oxides are the silica-aluminas. Most preferred is silica. The silica may be in granular, agglomerated, fumed or other form. The support is preferably a silica compound. In a preferred embodiment, the metallocene catalyst is provided on a solid support, preferably a silica support. In an embodiment, the catalyst used for preparing the polyolefin is a supported metallocene-alumoxane catalyst comprising a metallocene and an alumoxane which are bound on a porous silica support.

In some embodiments, the polyolefin used in the polyolefin composition is a multimodal polyolefin prepared in the presence of a metallocene catalyst. For example, the polyolefin can be a bimodal polyethylene prepared in the presence of a metallocene catalyst.

In an embodiment, the polymer composition comprises at least one polyamide. Polyamides are characterized in that the polymer chain comprises amide groups (—NH—C(═O)—). Polyamides useful in the present invention are preferably characterized by one of the following two chemical structures

[—NH—(CH₂)ₙ—C(═O)—]ₓ

[—NH—(CH₂)ₘ—NH—C(═O)—(CH₂)ₙ—C(═O)]ₓ

wherein m and n may be independently chosen from one another and be an integer from 1 to 20.

Specific examples of suitable polyamides are polyamides 4, 6, 7, 8, 9, 10, 11, 12, 46, 66, 610, 612 and 613.

In an embodiment, the polymer composition comprises at least one polystyrene. The polystyrenes used in the present invention may be any styrene homopolymer or copolymer. They may be atactic, syndiotactic or isotactic. Styrene copolymers comprise one or more suitable comonomers, i.e. polymerizable compounds different from styrene. Examples of suitable comonomers are butadiene, acrylonitrile, acrylic acid or methacrylic acid. Examples of styrene copolymers that may be used in the present invention are butadiene-styrene copolymers, which are also referred to as high-impact polystyrene (HIPS), acrylonitrile-butadiene-styrene copolymers (ABS) or styrene-acrylonitrile copolymers (SAN).

In an embodiment, the polymer composition comprises at least one polyester. Polyesters that may be used in the present invention are preferably characterized by the following chemical structure

[—C(═O)—C₆H₄—C(═O)O—(CH₂—CH₂)ₙ—O—]ₓ

wherein n is an integer from 1 to 10, with preferred values being 1 or 2.

Specific examples of suitable polyesters are polyethylene terephthalate (PET) and polybutylene terephthalate (PBT).

Furthermore, preferred polyesters are poly(hydroxy carboxylic acid)s. From a standpoint of availability and transparency, the poly(hydroxy carboxylic acid) is preferably a polylactic acid (PLA). Preferably the polylactic acid is a homopolymer obtained either directly from lactic acid or from lactide, preferably from lactide.

In an embodiment of the invention, the polymeric composition comprises one or more additives selected from the group comprising an antioxidant, an antiacid, a UV-absorber, an antistatic agent, a light stabilizing agent, an acid scavenger, a lubricant, a nucleating/clarifying agent, a colorant or a peroxide. An overview of suitable additives may be found in Plastics Additives Handbook, ed. H. Zweifel, 5^{th} edition, 2001, Hanser Publishers, which is hereby incorporated by reference in its entirety.

The invention also encompasses the polymeric composition as described herein wherein the polymeric composition comprises from 0% to 10% by weight of at least one additive, based on the total weight of the polymeric composition. In a preferred embodiment, said polymeric composition comprises less than 5% by weight of additive, based on the total weight of the polymeric composition, for example from 0.1 to 3% by weight of additive, based on the total weight of the polymeric composition.

In a preferred embodiment, the polymeric composition comprises an antioxidant. Suitable antioxidants include, for example, phenolic antioxidants such as pentaerythritol tetrakis[3-(3′,5′-di-tert-butyl-4′-hydroxyphenyl)propionate] (herein referred to as Irganox 1010), tris(2,4-ditert-butylphenyl) phosphite (herein referred to as Irgafos 168), 3DL-alpha-tocopherol, 2,6-di-tert-butyl-4-methylphenol, dibutylhydroxyphenylpropionic acid stearyl ester, 3,5-di-tert-butyl-4-hydroxyhydrocinnamic acid, 2,2′-methylenebis(6-tert-butyl-4-methyl-phenol), hexamethylene bis[3-(3,5-di-tert-butyl-4-hydroxyphenyl)propionate], benzenepropanamide,N,N′-1,6-hexanediyl bis[3,5-bis(1,1-dimethylethyl)-4-hydroxy] (Antioxidant 1098), Diethyl 3.5-Di-Tert-Butyl-4-Hydroxybenzyl Phosphonate, Calcium bis[monoethyl(3,5-di-tert-butyl-4-hydroxylbenzyl)phosphonate], Triethylene glycol bis(3-tert-butyl-4-hydroxy-5-methylphenyl)propionate (Antioxidant 245), 6,6′-di-tert-butyl-4,4′-butylidenedi-m-cresol, 3,9-bis(2-(3-(3-tert-butyl-4-hydroxy-5-methylphenyl)propionyloxy-1,1-dimethylethyl)-2,4,8,10-tetraoxaspiro[5.5]undecane, 1,3,5-trimethyl-2,4,6-tris(3,5-di-tert-butyl-4-hydroxybenzyl)benzene, 1,1,3-tris(2-methyl-4-hydroxy-5-tert-butylphenyl)butane, (2,4,6-trioxo-1,3,5-triazine-1,3,5(2H,4H,6H)-triyl)triethylene tris[3-(3,5-di-tert-butyl-4-hydroxyphenyl)propionate], tris(3,5-di-tert-butyl-4-hydroxybenzyl) isocyanurate, Tris(4-tert-butyl-3-hydroxy-2,6-dimethylbenzyl) isocyanurate, ethylene bis[3,3-bis(3-tert-butyl-4-hydroxyphenyl)butyrate], and 2,6-bis[[3-(1,1-dimethylethyl)-2-hydroxy-5-methylphenyl]octahydro-4,7-methano-1H-indenyl]-4-methyl-phenol. Suitable antioxidants also include, for example, phenolic antioxidants with dual functionality such 4,4′-Thio-bis(6-tert-butyl-m-methyl phenol) (Antioxidant 300), 2,2′-Sulfanediylbis(6-tert-butyl-4-methylphenol) (Antioxidant 2246-S), 2-Methyl-4,6-bis(octylsulfanylmethyl)phenol, thiodiethylene bis[3-(3,5-di-tert-butyl-4-hydroxyphenyl)propionate], 2,6-di-tert-butyl-4-(4,6-bis(octylthio)-1,3,5-triazin-2-ylamino)phenol, N-(4-hydroxyphenyl)stearamide, bis(1,2,2,6,6-pentamethyl-4-piperidyl) [[3,5-bis(1,1-dimethylethyl)-4-hydroxyphenyl]methyl]butylmalonate, 2,4-di-tert-butylphenyl 3,5-di-tert-butyl-4-hydroxybenzoate, hexadecyl 3,5-di-tert-butyl-4-hydroxy-benzoate, 2-(1,1-dimethylethyl)-6[[3-(1,1-dimethylethyl)-2-hydroxy-5-methylphenyl]methyl]-4-methylphenyl acrylate, and Cas nr. 128961-68-2 (Sumilizer GS). Suitable antioxidants also include, for example, aminic antioxidants such as N-phenyl-2-naphthylamine, poly(1,2-dihydro-2,2,4-trimethyl-quinoline), N-isopropyl-N′-phenyl-p-phenylenediamine, N-Phenyl-1-naphthylamine, CAS nr. 68411-46-1 (Antioxidant 5057), and 4,4-bis(alpha,alpha-dimethylbenzyl)diphenylamine (Antioxidant KY 405). In a preferred embodiment, the antioxidant is selected from pentaerythritol tetrakis[3-(3′,5′-di-tert-butyl-4′-hydroxyphenyl)propionate] (herein referred to as Irganox 1010), tris(2,4-ditert-butylphenyl) phosphite (herein referred to as Irgafos 168), or a mixture thereof.

In a preferred embodiment of the invention, the polymer composition, preferably a polyolefin composition, is in the form of a fluff, powder, or pellet, preferably in the form of a fluff.

As used herein, the term “fluff” refers to the polymer material that is prepared in a loop reactor with the hard catalyst particle at the core of each grain of the powder. As used herein the term “resin” encompasses both the fluff prepared in the loop reactor as well as the subsequently melted and/or pelleted polymer.

As used herein, the terms “polymer product” or “polymer pellet” are defined as polymer material that is prepared through compounding and homogenizing of the resin, for instance with mixing and/or extruder equipment. Preferably, the polymer particles have an average diameter (D50) of at most 2 mm, more preferably at most 1 mm, more preferably at most 100 μm. The D50 is defined as the particle size for which fifty percent by volume of the particles has a size lower than the D50. The average size of the particles is preferably assessed by particle sieving. Alternatively, the size may be measured by using optical measurements, preferably with a Camsizer.

As used herein, the term “polymer powder” refers to ground polymer fluff or ground polymer pellets.

Preferably, the polymeric compositions are processed at a temperature above the melt temperature, i.e. they are melt-processed. In a preferred embodiment of the invention, step (c) of the process of the present invention is performed at a temperature above the melt temperature of said polymeric composition (also referred to as a “melt-processing step”), preferably wherein step (c) comprises extruding a mixture of the polymer composition and the covalently grafted carbonaceous material in an extruder.

The melt temperature of the polymeric composition can for example be determined by differential scanning calorimetry (DSC). The DSC can be performed with a Perkin-Elmer Pyris 1 equipment. In a typical DSC experiment, the sample is first heated up to 200° C. at a 20° C./min rate in order to fully melt the polymeric composition and remove its thermomechanical history. The sample is held at 200° C. during 3 min. Then the sample is cooled down to −40° C. at a 20° C./min rate and heated up again at 200° C. at 20° C./min. The melt temperature is measured during the second heating step and corresponds to the maximum of the melting peak. The standard used to calibrate the heating and cooling rate is Indium. It is noted that generally the melt temperature of the polymeric composition will be substantially the same as that of the polymer composition.

Said melt-processing step (c) can for example be a pelletization, i.e. the production of pellets by melt-extruding the polymeric composition, or step (c) can be a process selected from the group comprising fiber extrusion, film extrusion, sheet extrusion, pipe extrusion, blow molding, rotomolding, slush molding, injection molding, injection-stretch blow molding and extrusion-thermoforming. Most preferably, step (c) is a process selected from the group comprising pelletization, fiber extrusion, film extrusion, sheet extrusion and rotomolding.

The present invention preferably relates to extrusion. As used herein, the terms “extrusion” or “extrusion process”, “pelletization” or “pelletizing” are used herein as synonyms and refer to the process of transforming polymer resin into a “polymer product” or into “pellets” after pelletizing. The process preferably comprises several equipments connected in series, including one or more rotating screws in an extruder, a die, and means for cutting the extruded filaments into pellets.

Preferably, polymer resin is fed to the extruding apparatus through a valve, preferably a feeding screw or a rotary valve, and conveyed—while passing a flow meter- to the at least one feeding zone of the extrusion apparatus. Preferably, nitrogen is provided in the feeding zone to prevent air from entering the extrusion apparatus, to thereby limit polymer degradation.

After being fed into the extruder, the polymer resin is preferably transported along with the rotating screw of the extruder. High shear forces are present in the extruder and product temperature increases. The polymer product, optionally in the presence of additives, melts and is homogenized and mixed.

The extruder can have one or more heating means e.g. a jacket to heat the extruder barrels or a hot oil unit. The screw in the extruder can be the vehicle upon which the polymer product travels. The shape of the screw can determine, along with the speed at which the screw turns, expressed in rpm, the speed at which the product moves and the pressure attained in the extruder. The screw in the screw mixer can be powered by a motor, preferably an electric motor.

In a preferred embodiment of the invention, the extruder has a screw speed from 10 to 2000 rpm, for example from 100 to 1000 rpm, for example from 150 to 300 rpm.

The melted and homogenized polymer product may further be pumped and pressurized by a pump at the end of the extruder, preferably powered by an electrical motor. Preferably, the melted polymer product is further filtered by means of a filter to remove impurities and to reduce the amount of gels. Preferably, the product is then pushed through a die, preferably a die plate, provided in a pelletizer. In an embodiment, the polymer comes out of the die plate as a large number of noodles which are then delivered into pellet cooling water and cut underwater in the pelletizer by rotating knives. The particles can be cooled down with the water and form the pellets which are transported to further processing sections, e.g. to a packaging section.

Preferably, the polymeric compositions are processed at a temperature below the decomposition temperature of the polymeric composition. As used herein, the decomposition temperature of the polymeric composition is equal to the decomposition temperature as the polymer composition. In a preferred embodiment of the invention, the temperature is from 150° C. to 300° C., preferably from 200° C. to 250° C.

According to a third aspect, the invention encompasses the covalently grafted carbonaceous material obtained by a process according to the first aspect of the invention or the polymeric composite obtained by the process according to the second aspect of the invention.

The invention also encompasses formed articles comprising the covalently grafted carbonaceous material obtained by a process according to the first aspect of the invention or formed articles comprising the polymeric composite obtained by the process according to the second aspect of the invention. Preferred articles are fibers, films, sheets, rotomolded articles, pipes, artificial joints, dental applications, watercraft, containers, foams, and injection molded articles. Most preferred articles are fibers, films, sheets, and rotomolded articles.

The preparation of covalently grafted carbonaceous material is illustrated by the following examples.

### EXAMPLES

### Test Methods

The XPS analysis was performed using a THERMO Scientific K-Alpha spectrometer, equipped with a monochromatized Al anode (1486.6 eV). The X-ray source was characterized by a voltage of 12 kV and an intensity of 1.8 mA. The spot size was 200 μm. A flood gun (electrons and Ar ions at very low energy) was used to avoid possible charging effect. The analyzer (Spherical Deflection Analyzer) was operated at constant pass energy (CAE) to ensure a constant energy resolution over the whole spectrum. The pressure in the chamber was in the range 10-8 mbar. The experimental data were treated using Avantage software. The accuracy of XPS was about 1%.

For grafting with 4-hydroxyaniline (Examples 1-2, 17-19), the oxygen and nitrogen spectra were analyzed, and the percentage of nitrogen in diazo form was measured. For examples 1 and 2 the percentage of C—O bond was measured.

For grafting with 4-trifluoromethylaniline (Examples 3-4, 20-74), the nitrogen, oxygen and fluorine spectra were analyzed.

For grafting with 4-carboxyaniline (Examples 5-6), the nitrogen and oxygen spectra were analyzed. The percentage of C(O)—O bond was measured.

For grafting with 4-aminothiophenol (Examples 7-8, 75-102), the nitrogen, oxygen and sulfur spectra were analyzed.

For grafting with 3-aminothiophenol (Examples 9-10, 103-114), the nitrogen, oxygen and sulfur spectra were analyzed.

For grafting with 4-nitroaniline (Examples 11-12), the nitrogen and oxygen spectra were analyzed, and the percentage of nitrogen in nitro form was measured.

For grafting with 4-(1H-pyrrol-1-yl)aniline (Examples 13-14), the nitrogen and oxygen spectra were analyzed.

For grafting with 4-tetradecylaniline (Example 15), the nitrogen, oxygen and carbon spectra were analyzed, and the percentage of aliphatic carbon was measured.

For grafting with 4-heptadecafluorooctylaniline (Example 16), the nitrogen, oxygen and fluorine spectra were analyzed.

Apart from the OH, CO and C(O)O contributions explicitly mentioned in the examples, no additional oxidation was observed for all examples.

Sample Preparation

All examples were conducted with 20 mg of multi-walled carbon nanotubes Nanocyl™ NC 7000, commercially available from Nanocyl, which have an apparent density of 50-150 kg/m³, a mean agglomerate size of 200-500 μm, a carbon content of more than 90% by weight, a mean number of 5-15 walls, an outer mean diameter of 10-15 nm and a length of 0.1-10 μm. Example 4 was also duplicated with double-walled nanotubes Nanocyl™ NC 2100, commercially available from Nanocyl, which have a carbon content of more than 90% by weight, an outer mean diameter of 3.5 nm and a length of 1-10 μm. With double-walled nanotubes, the F signal rose from 4.0% to 6.0% compared to the multi-walled nanotubes.

The carbon nanotubes were weighted in a 20 ml scintillation flask (opening diameter 16 mm). The reactant, and optionally a co-reactant were then added. 10.0 ml of a solvent was then used to solubilize the components, and optionally a co-solvent was added to assist diazonium salt formation.

The scintillation flask was then kept under IR radiation (OSRAM 150 Watts IR lamp, at 17 cm of distance) and under stirring (700 rpm) for a specific time. The resulting carbon nanotubes were then extensively washed with water, followed by acetone and then pentane.

### Examples 1-16

The amounts of reactant, co-reactant (sodium nitrite), solvent, and co-solvent (perchloric acid) for Examples 1-16 are shown in Tables 1A and 1B. The time of irradiation was kept constant at 60 minutes, while the reactant was selected from the following commercially available compound list: 4-hydroxyaniline, 4-trifluoromethylaniline, 4-carboxyaniline, 4-aminothiophenol (4-thioaniline), 3-aminothiophenol (3-thioaniline), 4-nitroaniline, 4-(1H-pyrrol-1-yl)aniline, 4-tetradecylaniline, and 4-heptadecafluorooctylaniline. In Table 1A, the solvent was distillated water, while in Table 1B, the solvent was acetonitrile.

For examples 1 and 2, XSP data showed that 88% and 94% of the nitrogen was on a diazo bridge form. For examples 11 and 12, 80% of the nitrogen was measured as nitro component.

For examples 1 and 2, the carbon XPS spectrum showed a strong contribution of C—O bonds. This contribution can be estimated at 6% of the carbon for example 1 and 4% of the carbon for example 2 (with an error of at most 2%).

TABLE 1A

| | Example | Example | Example | Example | Example | Example | Example | Example | Example |
|---|---|---|---|---|---|---|---|---|---|
| | 1 | 3 | 5 | 7 | 9 | 11 | 13 | 15 | 16 |
| reactant (mole) | | | | | | | | | |
| 4-hydroxyaniline | 6.9 10⁻⁴ | — | — | — | — | — | — | — | — |
| 4-trifluoro- | — | 6.9 10⁻⁴ | — | — | — | — | — | — | — |
| methylaniline | | | | | | | | | |
| 4-carboxyaniline | — | — | 6.9 10⁻⁴ | — | — | — | — | — | — |
| 4-aminothiophenol | — | — | — | 6.9 10⁻⁴ | — | — | — | — | — |
| 3-aminothiophenol | — | — | — | — | 6.9 10⁻⁴ | — | — | — | — |
| 4-nitroaniline | — | — | — | — | — | 6.9 10⁻⁴ | — | — | — |
| 4-(1H-pyrrol-1- | — | — | — | — | — | — | 6.9 10⁻⁴ | — | — |
| yl)aniline | | | | | | | | | |
| 4-tetradecylaniline | — | — | — | — | — | — | — | 6.9 10⁻⁴ | |
| 4-heptadecafluoro- | — | — | — | — | — | — | — | — | 6.9 10⁻⁴ |
| octylaniline | | | | | | | | | |
| co-reactant (mole) | | | | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | | | | |
| distillated water | 10.0 | 10.0 | 10.0 | 10.0 | 10.0 | 10.0 | 10.0 | 10.0 | 10.0 |
| acetonitrile | — | — | — | — | — | — | — | — | — |
| co-solvent (mole) | | | | | | | | | |
| perchloric acid | 8.0 10⁻⁴ | 8.0 10⁻⁴ | 8.0 10⁻⁴ | 8.0 10⁻⁴ | 8.0 10⁻⁴ | 8.0 10⁻⁴ | 8.0 10⁻⁴ | 8.0 10⁻⁴ | 8.0 10⁻⁴ |
| time (min) | 60 | 60 | 60 | 60 | 60 | 60 | 60 | 60 | 60 |
| XPS (%) | | | | | | | | | |
| N | 1.0 | — | 1.2 | 4.2 | 4.6 | 4.1 | 15.0 | 1.0 | — |
| F | — | 9.3 | — | — | — | — | — | — | 24.0 |
| S | — | — | — | 7.2 | 7.8 | — | — | — | — |
| CO | 6 | — | — | | — | — | — | — | — |
| C—(O)O | — | — | 4.0 | — | — | — | — | — | — |
| aliphatic C | — | — | — | — | — | — | — | 35 | — |

TABLE 1B

| | Example | Example | Example | Example | Example | Example | Example |
|---|---|---|---|---|---|---|---|
| | 2 | 4 | 6 | 8 | 10 | 12 | 14 |
| reactant (mole) | | | | | | | |
| 4-hydroxyaniline | 6.9 10⁻⁴ | — | — | — | — | — | — |
| 4-trifluoro- | — | 6.9 10⁻⁴ | — | — | — | — | — |
| methylaniline | | | | | | | |
| 4-carboxyaniline | — | — | 6.9 10⁻⁴ | — | — | — | — |
| 4-aminothiophenol | — | — | — | 6.9 10⁻⁴ | — | — | — |
| 3-aminothiophenol | — | — | — | — | 6.9 10⁻⁴ | — | — |
| 4-nitroaniline | — | — | — | — | — | 6.9 10⁻⁴ | — |
| 4-(1H-pyrrol-1- | — | — | — | — | — | — | 6.9 10⁻⁴ |
| yl)aniline | | | | | | | |
| 4-tetradecylaniline | — | — | — | — | — | — | — |
| 4-heptadeca- | — | — | — | — | — | — | — |
| fluorooctylaniline | | | | | | | |
| co-reactant (mole) | | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | | |
| distillated water | — | — | — | — | — | — | — |
| acetonitrile | 10.0 | 10.0 | 10.0 | 10.0 | 10.0 | 10.0 | 10.0 |
| co-solvent (mole) | | | | | | | |
| perchloric acid | 8.0 10⁻⁴ | 8.0 10⁻⁴ | 8.0 10⁻⁴ | 8.0 10⁻⁴ | 8.0 10⁻⁴ | 8.0 10⁻⁴ | 8.0 10⁻⁴ |
| time (min) | 60 | 60 | 60 | 60 | 60 | 60 | 60 |
| XPS (%) | | | | | | | |
| N | 3.0 | — | 1.5 | 3.2 | 3.3 | 2.6 | 14.0 |
| F | — | 4.0 | — | — | — | — | — |
| S | — | — | — | 6.5 | 6.2 | — | — |
| CO | 4 | — | — | — | — | — | — |
| C—(O)O | — | — | 5.6 | — | — | — | — |
| aliphatic C | — | — | — | — | — | — | — |

### Examples 17-20

The amounts of reactant (4-hydroxyaniline), co-reactant (sodium nitrite), solvent, and co-solvent (perchloric acid) for Examples 17-20 are shown in Table 2, in comparison with Examples 1 and 2. The time of irradiation in examples 17 and 18 was 120 minutes instead of 60 minutes. The amount of co-solvent in Example 19 was 1.6 10⁻³ mole instead of 8.0 10⁻⁴ mole. The amount of reactant in Example 20 was 13.2 10⁻⁴ mole instead of 6.9 10⁻⁴ mole. For examples 1, 2, and 17-20, XPS characterization showed an increase in the oxygen content, which could be linked to an increase in —OH functions.

TABLE 2

| | Example | Example | Example | Example | Example | Example |
|---|---|---|---|---|---|---|
| | 1 | 2 | 17 | 18 | 19 | 20 |
| reactant (mole) | | | | | | |
| 4-hydroxyaniline | 6.9 10⁻⁴ | 6.9 10⁻⁴ | 6.9 10⁻⁴ | 6.9 10⁻⁴ | 6.9 10⁻⁴ | 13.2 10⁻⁴ |
| co-reactant (mole) | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | |
| distillated water | 10.0 | — | 10.0 | — | 10.0 | 10.0 |
| acetonitrile | — | 10.0 | — | 10.0 | — | — |
| co-solvent (mole) | | | | | | |
| perchloric acid | 8.0 10⁻⁴ | 8.0 10⁻⁴ | 8.0 10⁻⁴ | 8.0 10⁻⁴ | 1.6 10⁻³ | 1.6 10⁻³ |
| time (min) | 60 | 60 | 120 | 120 | 60 | 60 |
| XPS (%) | | | | | | |
| N | 1.0 | 3.0 | 1.3 | 3.0 | 1.4 | 1.8 |
| diazo | 88 | 94 | 90 | 71 | 88 | 84 |

### Example 21

The amounts of reactant (4-trifluoromethylaniline), co-reactant (sodium nitrite), solvent, and co-solvent (perchloric acid) for Example 21 are shown in Table 3, in comparison with Examples 3 and 4. The co-solvent in example 21 was ethanol instead of distillated water or acetonitrile.

TABLE 3

| | Example 3 | Example 4 | Example 21 |
|---|---|---|---|
| reactant (mole) | | | |
| 4-trifluoromethylaniline | 6.9 10⁻⁴ | 6.9 10⁻⁴ | 6.9 10⁻⁴ |
| co-reactant (mole) | | | |
| sodium nitrite | 6.6 10⁻⁴ | 6.6 10⁻⁴ | 6.6 10⁻⁴ |
| solvent (ml) | | | |
| distillated water | 10.0 | — | — |
| acetonitrile | — | 10.0 | — |
| ethanol | — | — | 10.0 |
| co-solvent (mole) | | | |
| perchloric acid | 8.0 10⁻⁴ | 8.0 10⁻⁴ | 8.0 10⁻⁴ |
| time (min) | 60 | 60 | 60 |
| XPS (%) | | | |
| F | 9.3 | 4.0 | 5.3 |

### Examples 22-28

The amounts of reactant (4-trifluoromethylaniline), co-reactant (sodium nitrite), solvent (distillated water), and co-solvent (perchloric acid) for Examples 22-28 are shown in Table 4, in comparison with Example 3. The amount of co-solvent varied from 8.0 10⁻⁵ to 2.4 10⁻³ mole.

TABLE 4

| | Example | Example | Example | Example | Example | Example | Example | Example |
|---|---|---|---|---|---|---|---|---|
| | 22 | 23 | 24 | 3 | 25 | 26 | 27 | 28 |
| reactant (mole) | | | | | | | | |
| 4-trifluoro- | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ |
| methylaniline | | | | | | | | |
| co-reactant (mole) | | | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | | | |
| distillated water | 10.0 | 10.0 | 10.0 | 10.0 | 10.0 | 10.0 | 10.0 | 10.0 |
| co-solvent (mole) | | | | | | | | |
| perchloric acid | 8.0 10⁻⁵ | 1.6 10⁻⁴ | 4.0 10⁻⁴ | 8.0 10⁻⁴ | 1.2 10⁻³ | 1.6 10⁻³ | 2.0 10⁻³ | 2.4 10⁻³ |
| time (min) | 60 | 60 | 60 | 60 | 60 | 60 | 60 | 60 |
| XPS (%) | | | | | | | | |
| F | 4.4 | 4.5 | 8.3 | 9.3 | 8.5 | 8.2 | 8.1 | 9.1 |

### Examples 29-34

The amounts of reactant (4-trifluoromethylaniline), co-reactant (sodium nitrite), solvent (acetonitrile), and co-solvent (perchloric acid) for Examples 29-34 are shown in Table 5, in comparison with Example 4. The amount of co-solvent varied from 1.6 10⁻⁴ to 2.410⁻³ mole.

### Examples 35-40

The amounts of reactant (4-trifluoromethylaniline), co-reactant (sodium nitrite), solvent (ethanol), and co-solvent (perchloric acid) for Examples 35-40 are shown in Table 6, in comparison with Example 21. The amount of co-solvent varied from 1.6 10⁻⁴ to 2.4 10⁻³ mole.

### Examples 41-47

The amounts of reactant (4-trifluoromethylaniline), co-reactant, solvent, and co-solvent for Examples 41-47 are shown in Table 7, in comparison with Examples 3, 4 and 21. The co-reactant was sodium nitrite or isoamyl nitrite, the solvent was distillated water, acetonitrile or ethanol, and the co-solvent was perchloric acid, sodium hydroxide, or neither.

TABLE 5

| | Example | Example | Example | Example | Example | Example | Example |
|---|---|---|---|---|---|---|---|
| | 29 | 30 | 4 | 31 | 32 | 33 | 34 |
| reactant (mole) | | | | | | | |
| 4-trifluoro- | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ |
| methylaniline | | | | | | | |
| co-reactant (mole) | | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | | |
| acetonitrile | 10.0 | 10.0 | 10.0 | 10.0 | 10.0 | 10.0 | 10.0 |
| co-solvent (mole) | | | | | | | |
| perchloric acid | 1.6 10⁻⁴ | 4.0 10⁻⁴ | 8.0 10⁻⁴ | 1.2 10⁻³ | 1.6 10⁻³ | 2.0 10⁻³ | 2.4 10⁻³ |
| time (min) | 60 | 60 | 60 | 60 | 60 | 60 | 60 |
| XPS (%) | | | | | | | |
| F | 3.1 | 4.0 | 4.0 | 1.8 | 1.8 | 1.1 | 1.6 |

TABLE 6

| | Example | Example | Example | Example | Example | Example | Example |
|---|---|---|---|---|---|---|---|
| | 35 | 36 | 21 | 37 | 38 | 39 | 40 |
| reactant (mole) | | | | | | | |
| 4-trifluoro- | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ |
| methylaniline | | | | | | | |
| co-reactant (mole) | | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | | |
| ethanol | 10.0 | 10.0 | 10.0 | 10.0 | 10.0 | 10.0 | 10.0 |
| co-solvent (mole) | | | | | | | |
| perchloric acid | 1.6 10⁻⁴ | 4.0 10⁻⁴ | 8.0 10⁻⁴ | 1.2 10⁻³ | 1.6 10⁻³ | 2.0 10⁻³ | 2.4 10⁻³ |
| time (min) | 60 | 60 | 60 | 60 | 60 | 60 | 60 |
| XPS (%) | | | | | | | |
| F | 0.5 | 3.3 | 5.3 | 5.1 | 4.5 | 5.2 | 4.9 |

TABLE 7

| | Example | Example | Example | Example | Example | Example | Example | Example | Example | Example |
|---|---|---|---|---|---|---|---|---|---|---|
| | 3 | 41 | 4 | 42 | 43 | 44 | 21 | 45 | 46 | 47 |
| reactant (mole) | | | | | | | | | | |
| 4-trifluoro- | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ |
| methylaniline | | | | | | | | | | |
| co-reactant (mole) | | | | | | | | | | |
| sodium nitrite | 6.6 10⁻⁴ | — | 6.6 10⁻⁴ | — | — | — | 6.6 10⁻⁴ | — | — | — |
| isoamyl nitrite | — | 6.6 10⁻⁴ | — | 6.6 10⁻⁴ | 6.6 10⁻⁴ | 6.6 10⁻⁴ | — | 6.6 10⁻⁴ | 6.6 10⁻⁴ | 6.6 10⁻⁴ |
| solvent (ml) | | | | | | | | | | |
| distillated water | 10.0 | 10.0 | — | — | — | — | — | — | — | — |
| acetonitrile | — | — | 10.0 | 10.0 | 10.0 | 10.0 | — | — | — | — |
| ethanol | — | — | — | — | — | — | 10.0 | 10.0 | 10.0 | 10.0 |
| co-solvent (mole) | | | | | | | | | | |
| perchloric acid | 8.0 10⁻⁴ | — | 8.0 10⁻⁴ | 8.0 10⁻⁴ | — | — | 8.0 10⁻⁴ | 8.0 10⁻⁴ | — | — |
| NaOH | — | — | — | — | 8.0 10⁻⁴ | — | — | — | 8.0 10⁻⁴ | — |
| time (min) | 60 | 60 | 60 | 60 | 60 | 60 | 60 | 60 | 60 | 60 |
| XPS (%) | | | | | | | | | | |
| F | 9.3 | 2.8 | 4.0 | 2.6 | 2.0 | 0.4 | 5.3 | 7.3 | 1.5 | 0.0 |

### Examples 48-73

The amounts of co-reactant (sodium nitrite) and co-solvent (perchloric acid), and the irradiation time for Examples 48-73 are shown in Tables 8A, 8B, 8C, 8D, 8E, 8F, 8G and 8F, in comparison with Examples 3, 23 and 26. The reactant was 6.9 10⁻⁴ mole of 4-trifluoromethylaniline, and the solvent was 10.0 ml of distillated water.

Table 8A shows a variable irradiation time of from 20 to 120 minutes for a co-reactant (sodium nitrite) amount of 6.6 10⁻⁴ mole and a co-solvent (perchloric acid) amount of 1.6 10⁻⁴ mole.

Table 8B shows a variable irradiation time of from 20 to 240 minutes for a co-reactant (sodium nitrite) amount of 6.6 10⁻⁴ mole and a co-solvent (perchloric acid) amount of 8.0 10⁻⁴ mole.

Table 8C shows a variable irradiation time of from 20 to 120 minutes for a co-reactant (sodium nitrite) amount of 6.6 10⁻⁴ mole and a co-solvent (perchloric acid) amount of 1.6 10⁻³ mole.

Table 8D shows a variable irradiation time of from 20 to 120 minutes for a co-reactant (sodium nitrite) amount of 1.3 10⁻³ mole and a co-solvent (perchloric acid) amount of 8.0 10⁻⁴ mole.

Table 8E shows a variable irradiation time of from 20 to 120 minutes for a co-reactant (sodium nitrite) amount of 1.3 10⁻³ mole and a co-solvent (perchloric acid) amount of 1.6 10⁻³ mole.

Table 8F shows a variable irradiation time of from 20 to 120 minutes for a co-reactant (sodium nitrite) amount of 2.0 10⁻³ mole and a co-solvent (perchloric acid) amount of 1.6 10⁻³ mole.

Table 8G shows a variable irradiation time of from 20 to 120 minutes for a co-reactant (sodium nitrite) amount of 2.0 10⁻³ mole and a co-solvent (perchloric acid) amount of 2.4 10⁻³ mole.

TABLE 8A

| | | | | Example |
|---|---|---|---|---|
| | Example 48 | Example 49 | Example 23 | 50 |
| co-reactant (mole) | | | | |
| sodium nitrite | 6.6 10⁻⁴ | 6.6 10⁻⁴ | 6.6 10⁻⁴ | 6.6 10⁻⁴ |
| co-solvent (mole) | | | | |
| perchloric acid | 1.6 10⁻⁴ | 1.6 10⁻⁴ | 1.6 10⁻⁴ | 1.6 10⁻⁴ |
| time (min) | 20 | 40 | 60 | 120 |
| XPS (%) | | | | |
| F | 3.7 | 3.4 | 4.5 | 4.8 |

TABLE 8B

| | Example | Example | | Example | Example |
|---|---|---|---|---|---|
| | 51 | 52 | Example 3 | 53 | 54 |
| co-reactant | | | | | |
| (mole) | | | | | |
| sodium | 6.6 10⁻⁴ | 6.6 10⁻⁴ | 6.6 10⁻⁴ | 6.6 10⁻⁴ | 6.6 10⁻⁴ |
| nitrite | | | | | |
| co-solvent | | | | | |
| (mole) | | | | | |
| perchloric | 8.0 10⁻⁴ | 8.0 10⁻⁴ | 8.0 10⁻⁴ | 8.0 10⁻⁴ | 8.0 10⁻⁴ |
| acid | | | | | |
| time (min) | 20 | 40 | 60 | 120 | 240 |
| XPS (%) | | | | | |
| F | 5.3 | 8.4 | 9.3 | 11.2 | 11.4 |

TABLE 8C

| | | | | Example |
|---|---|---|---|---|
| | Example 55 | Example 56 | Example 26 | 57 |
| co-reactant (mole) | | | | |
| sodium nitrite | 6.6 10⁻⁴ | 6.6 10⁻⁴ | 6.6 10⁻⁴ | 6.6 10⁻⁴ |
| co-solvent (mole) | | | | |
| perchloric acid | 1.6 10⁻³ | 1.6 10⁻³ | 1.6 10⁻³ | 1.6 10⁻³ |
| time (min) | 20 | 40 | 60 | 120 |
| XPS (%) | | | | |
| F | 6.2 | 7.8 | 8.2 | 10.3 |

TABLE 8D

| | | | | Example |
|---|---|---|---|---|
| | Example 58 | Example 59 | Example 60 | 61 |
| co-reactant (mole) | | | | |
| sodium nitrite | 1.3 10⁻³ | 1.3 10⁻³ | 1.3 10⁻³ | 1.3 10⁻³ |
| co-solvent (mole) | | | | |
| perchloric acid | 8.0 10⁻⁴ | 8.0 10⁻⁴ | 8.0 10⁻⁴ | 8.0 10⁻⁴ |
| time (min) | 20 | 40 | 60 | 120 |
| XPS (%) | | | | |
| F | 7.6 | 10.1 | 10.7 | 10.4 |

TABLE 8E

| | | | | Example |
|---|---|---|---|---|
| | Example 62 | Example 63 | Example 64 | 65 |
| co-reactant (mole) | | | | |
| sodium nitrite | 1.3 10⁻³ | 1.3 10⁻³ | 1.3 10⁻³ | 1.3 10⁻³ |
| co-solvent (mole) | | | | |
| perchloric acid | 1.6 10⁻³ | 1.6 10⁻³ | 1.6 10⁻³ | 1.6 10⁻³ |
| time (min) | 20 | 40 | 60 | 120 |
| XPS (%) | | | | |
| F | 7.3 | 7.1 | 9.2 | 11.4 |

### Examples 74-76

The amounts of reactant (4-trifluoromethylaniline), co-reactant (sodium nitrite), solvent (acetonitrile), and co-solvent (perchloric acid), and the irradiation time for Examples 74-76 are shown in Table 9, in comparison with Example 4. The solvent was acetonitrile and the irradiation time varied from 20 to 120 minutes.

TABLE 9

| | Example | Example | | Example |
|---|---|---|---|---|
| | 74 | 75 | Example 4 | 76 |
| reactant (mole) | | | | |
| 4-trifluoromethylaniline | 6.9 10⁻⁴ | 6.9 10⁻⁴ | 6.9 10⁻⁴ | 6.9 10⁻⁴ |
| co-reactant (mole) | | | | |
| sodium nitrite | 6.6 10⁻⁴ | 6.6 10⁻⁴ | 6.6 10⁻⁴ | 6.6 10⁻⁴ |
| solvent (ml) | | | | |
| acetonitrile | 10.0 | 10.0 | 10.0 | 10.0 |
| co-solvent (mole) | | | | |
| perchloric acid | 8.0 10⁻⁴ | 8.0 10⁻⁴ | 8.0 10⁻⁴ | 8.0 10⁻⁴ |
| time (min) | 20 | 40 | 60 | 120 |
| XPS (%) | | | | |
| F | 6.1 | 6.7 | 4.0 | 6.2 |

### Examples 77-79

The amounts of reactant (4-trifluoromethylaniline), co-reactant (sodium nitrite), solvent (acetonitrile), and co-solvent (perchloric acid), and the irradiation time for Examples 77-79 are shown in Table 10, in comparison with Example 21. The solvent was ethanol and the irradiation time varied from 20 to 120 minutes.

TABLE 10

| | Example | Example | Example | Example |
|---|---|---|---|---|
| | 77 | 78 | 21 | 79 |
| reactant (mole) | | | | |
| 4-trifluoromethylaniline | 6.9 10⁻⁴ | 6.9 10⁻⁴ | 6.9 10⁻⁴ | 6.9 10⁻⁴ |
| co-reactant (mole) | | | | |
| sodium nitrite | 6.6 10⁻⁴ | 6.6 10⁻⁴ | 6.6 10⁻⁴ | 6.6 10⁻⁴ |
| solvent (ml) | | | | |
| ethanol | 10.0 | 10.0 | 10.0 | 10.0 |
| co-solvent (mole) | | | | |
| perchloric acid | 8.0 10⁻⁴ | 8.0 10⁻⁴ | 8.0 10⁻⁴ | 8.0 10⁻⁴ |
| time (min) | 20 | 40 | 60 | 120 |
| XPS (%) | | | | |
| F | 7.8 | 8.0 | 5.3 | 6.9 |

### Examples 80-81

The amounts of reactant (4-trifluoromethylaniline), co-reactant (sodium nitrite), solvent (distillated water), and co-solvent (perchloric acid) for Examples 80-81 are shown in Table 11, in comparison with Example 3. The amount of reactant (4-trifluoromethylaniline) varied from 6.9 10⁻⁴ mole to 1.37 10⁻³ mole.

TABLE 11

| | Example 3 | Example 80 | Example 81 |
|---|---|---|---|
| reactant (mole) | | | |
| 4-trifluoromethylaniline | 6.9 10⁻⁴ | 1.05 10⁻³ | 1.37 10⁻³ |
| co-reactant (mole) | | | |
| sodium nitrite | 6.6 10⁻⁴ | 6.6 10⁻⁴ | 6.6 10⁻⁴ |
| solvent (ml) | | | |
| distillated water | 10.0 | 10.0 | 10.0 |
| co-solvent (mole) | | | |
| perchloric acid | 8.0 10⁻⁴ | 8.0 10⁻⁴ | 8.0 10⁻⁴ |
| time (min) | 60 | 60 | 60 |
| XPS (%) | | | |
| F | 9.3 | 6.7 | 4.6 |

### Example 82

The amounts of reactant (4-aminothiophenol), co-reactant (sodium nitrite), solvent, and co-solvent (perchloric acid) for Example 82 are shown in Table 12, in comparison with Examples 7 and 8. Pyridine was used as the solvent in Example 82.

TABLE 12

| | Example 7 | Example 8 | Example 82 |
|---|---|---|---|
| reactant (mole) | | | |
| 4-aminothiophenol | 6.9 10⁻⁴ | 6.9 10⁻⁴ | 6.9 10⁻⁴ |
| co-reactant (mole) | | | |
| sodium nitrite | 6.6 10⁻⁴ | 6.6 10⁻⁴ | 6.6 10⁻⁴ |
| solvent (ml) | | | |
| distillated water | 10.0 | — | — |
| acetonitrile | — | 10.0 | — |
| pyridine | — | — | 10.0 |
| co-solvent (mole) | | | |
| perchloric acid | 8.0 10⁻⁴ | 8.0 10⁻⁴ | 8.0 10⁻⁴ |
| time (min) | 60 | 60 | 60 |
| XPS (%) | | | |
| N | 4.2 | 3.2 | 2.4 |
| diazo | 7.2 | 6.5 | 3.8 |

### Examples 83-87

The amounts of reactant (4-aminothiophenol), co-reactant (sodium nitrite), solvent (distillated water), and co-solvent (perchloric acid) for Examples 83-87 are shown in Table 13, in comparison with Example 7. The amount of reactant (4-aminothiophenol) varied from 6.9 10⁻⁴ mole to 2.76 10⁻³ mole, and the time of irradiation varied between 60 and 120 minutes.

TABLE 13

| | Example | Example | Example | Example | Example | Example |
|---|---|---|---|---|---|---|
| | 7 | 83 | 84 | 85 | 86 | 87 |
| reactant (mole) | | | | | | |
| 4-aminothiophenol | 6.9 10⁻⁴ | 1.38 10⁻³ | 2.76 10⁻³ | 6.9 10⁻⁴ | 1.38 10⁻³ | 2.76 10⁻³ |
| co-reactant (mole) | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | |
| distillated water | 10.0 | 10.0 | 10.0 | 10.0 | 10.0 | 10.0 |
| co-solvent (mole) | | | | | | |
| perchloric acid | 8.0 10⁻⁴ | 8.0 10⁻⁴ | 8.0 10⁻⁴ | 8.0 10⁻⁴ | 8.0 10⁻⁴ | 8.0 10⁻⁴ |
| time (min) | 60 | 60 | 60 | 120 | 120 | 120 |
| XPS (%) | | | | | | |
| N | 4.2 | 2.2 | 4.4 | 3.9 | 2.6 | 0.9 |
| diazo | 7.2 | 3.3 | 5.3 | 9 | 4 | 1.6 |

### Examples 88-94

The amounts of reactant (4-aminothiophenol), co-reactant (sodium nitrite), solvent (acetonitrile), and co-solvent (perchloric acid) for Examples 88-94 are shown in Table 14, in comparison with Example 8. The amount of reactant (4-aminothiophenol) varied from 1.9 10⁻⁴ mole to 2.76 10⁻³ mole, and the time of irradiation varied between 60 and 120 minutes.

TABLE 14

| | Example | Example | Example | Example | Example | Example | Example | Example |
|---|---|---|---|---|---|---|---|---|
| | 88 | 89 | 8 | 90 | 91 | 92 | 93 | 94 |
| reactant (mole) | | | | | | | | |
| 4-aminothiophenol | 1.9 10⁻⁴ | 3.7 10⁻⁴ | 6.9 10⁻⁴ | 1.38 10⁻³ | 2.76 10⁻³ | 6.9 10⁻⁴ | 1.38 10⁻³ | 2.76 10⁻³ |
| co-reactant (mole) | | | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | | | |
| acetonitrile | 10.0 | 10.0 | 10.0 | 10.0 | 10.0 | 10.0 | 10.0 | 10.0 |
| co-solvent (mole) | | | | | | | | |
| perchloric acid | 8.0 10⁻⁴ | 8.0 10⁻⁴ | 8.0 10⁻⁴ | 8.0 10⁻⁴ | 8.0 10⁻⁴ | 8.0 10⁻⁴ | 8.0 10⁻⁴ | 8.0 10⁻⁴ |
| time (min) | 60 | 60 | 60 | 60 | 60 | 120 | 120 | 120 |
| XPS (%) | | | | | | | | |
| N | 1.2 | — | 3.2 | 4.9 | 0.4 | 3.6 | 5.5 | 0.7 |
| diazo | 1.9 | — | 6.5 | 9.3 | 0.9 | 8.4 | 11.6 | 1.3 |

### Examples 95-99

The amounts of reactant (4-aminothiophenol), co-reactant (sodium nitrite), solvent (acetonitrile), and co-solvent (perchloric acid) for Examples 95-99 are shown in Table 15, in comparison with Example 8. The amount of reactant (4-aminothiophenol) varied from 6.9 10⁻⁴ mole to 2.76 10⁻³ mole, and the amount of co-solvent (perchloric acid) varied from 8.0 10⁻⁴ to 3.2 10⁻³ mole.

TABLE 15

| | Example | Example | Example | Example | Example | Example |
|---|---|---|---|---|---|---|
| | 8 | 95 | 96 | 97 | 98 | 99 |
| reactant (mole) | | | | | | |
| 4-aminothiophenol | 6.9 10⁻⁴ | 6.9 10⁻⁴ | 1.38 10⁻³ | 6.9 10⁻⁴ | 1.38 10⁻³ | 2.76 10⁻³ |
| co-reactant (mole) | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | |
| acetonitrile | 10.0 | 10.0 | 10.0 | 10.0 | 10.0 | 10.0 |
| co-solvent (mole) | | | | | | |
| perchloric acid | 8.0 10⁻⁴ | 1.6 10⁻³ | 1.6 10⁻³ | 3.2 10⁻³ | 3.2 10⁻³ | 3.2 10⁻³ |
| time (min) | 60 | 60 | 60 | 60 | 60 | 60 |
| XPS (%) | | | | | | |
| N | 3.2 | 1.0 | 3.2 | 2.0 | 2.3 | 1.2 |
| diazo | 6.5 | 1.2 | 7.0 | 3.2 | 1.0 | 1.2 |

### Examples 100-109

The amounts of reactant (4-aminothiophenol), co-reactant (sodium nitrite), solvent, and co-solvent (perchloric acid) for Examples 100-109 are shown in Table 16. The solvent varied between distillated water, acetonitrile and ethanol, and the time of irradiation varied between 20 and 120 minutes. The amount of co-solvent (perchloric acid) was 1.2 10⁻³ mole.

TABLE 16

| | Example | Example | Example | Example | Example | Example | Example | Example | Example | Example |
|---|---|---|---|---|---|---|---|---|---|---|
| | 100 | 101 | 102 | 103 | 104 | 105 | 106 | 107 | 108 | 109 |
| reactant (mole) | | | | | | | | | | |
| 4-aminothiophenol | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ | 6.9 10⁻⁴ |
| co-reactant (mole) | | | | | | | | | | |
| sodium nitrite | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ | 6.6 10⁻⁴ |
| solvent (ml) | | | | | | | | | | |
| distillated water | 10.0 | 10.0 | 10.0 | 10.0 | — | — | — | — | — | — |
| acetonitrile | — | — | — | — | 10.0 | 10.0 | — | — | — | — |
| ethanol | — | — | — | — | — | — | 10.0 | 10.0 | 10.0 | 10.0 |
| co-solvent (mole) | | | | | | | | | | |
| perchloric acid | 1.2 10⁻³ | 1.2 10⁻³ | 1.2 10⁻³ | 1.2 10⁻³ | 1.2 10⁻³ | 1.2 10⁻³ | 1.2 10⁻³ | 1.2 10⁻³ | 1.2 10⁻³ | 1.2 10⁻³ |
| time (min) | 20 | 40 | 60 | 120 | 20 | 120 | 20 | 40 | 60 | 120 |
| XPS (%) | | | | | | | | | | |
| N | 3.6 | 5.6 | 7.1 | 7.4 | 1.3 | 2.3 | 0.5 | — | — | 0.4 |
| diazo | 7.5 | 10.4 | 12.0 | 12.1 | 3.7 | 4.7 | 1.4 | 0.9 | 1.0 | 1.4 |

### Examples 110-113

The amounts of reactant (3-aminothiophenol), co-reactant (sodium nitrite), solvent (distillated water), and co-solvent (perchloric acid) for Examples 110-113 are shown in Table 17. The amount of co-solvent (perchloric acid) varied from 8.0 10⁻⁴ to 1.6 10⁻³ mole, and the time of irradiation varied between 20 and 120 minutes. The solvent was distillated water.

TABLE 17

| | | Example | Exam- | Exam- | Exam- |
|---|---|---|---|---|---|
| | Example 9 | 110 | ple 111 | ple 112 | ple 113 |
| reactant (mole) | | | | | |
| 3-aminothiophenol | 6.9 10⁻⁴ | 6.9 10⁻⁴ | 6.9 10⁻⁴ | 6.9 10⁻⁴ | 6.9 10⁻⁴ |
| co-reactant (mole) | | | | | |
| sodium nitrite | 6.6 10⁻⁴ | 6.6 10⁻⁴ | 6.6 10⁻⁴ | 6.6 10⁻⁴ | 6.6 10⁻⁴ |
| solvent (ml) | | | | | |
| distillated water | 10.0 | 10.0 | 10.0 | 10.0 | 10.0 |
| co-solvent (mole) | | | | | |
| perchloric acid | 8.0 10⁻⁴ | 1.6 10⁻³ | 1.2 10⁻³ | 1.2 10⁻³ | 1.2 10⁻³ |
| time (min) | 60 | 60 | 20 | 40 | 120 |
| XPS (%) | | | | | |
| N | 4.6 | 2.6 | 8.0 | 6.6 | 4.5 |
| diazo | 7.8 | 5.9 | 10.4 | 9.2 | 8.2 |

### Examples 114-117

The amounts of reactant (3-aminothiophenol), co-reactant (sodium nitrite), solvent (acetonitrile), and co-solvent (perchloric acid) for Examples 114-117 are shown in Table 18, compared to Example 10. The amount of co-solvent (perchloric acid) varied from 8.0 10′ to 1.6 10′ mole, and the time of irradiation varied between 20 and 120 minutes. The solvent was acetonitrile.

TABLE 18

| | Example | Example | Exam- | Exam- | Exam- |
|---|---|---|---|---|---|
| | 10 | 114 | ple 115 | ple 116 | ple 117 |
| reactant (mole) | | | | | |
| 3-aminothiophenol | 6.9 10⁻⁴ | 6.9 10⁻⁴ | 6.9 10⁻⁴ | 6.9 10⁻⁴ | 6.9 10⁻⁴ |
| co-reactant (mole) | | | | | |
| sodium nitrite | 6.6 10⁻⁴ | 6.6 10⁻⁴ | 6.6 10⁻⁴ | 6.6 10⁻⁴ | 6.6 10⁻⁴ |
| solvent (ml) | | | | | |
| acetonitrile | 10.0 | 10.0 | 10.0 | 10.0 | 10.0 |
| co-solvent (mole) | | | | | |
| perchloric acid | 8.0 10⁻⁴ | 1.6 10⁻³ | 1.2 10⁻³ | 1.2 10⁻³ | 1.2 10⁻³ |
| time (min) | 60 | 60 | 20 | 40 | 120 |
| XPS (%) | | | | | |
| N | 3.3 | 1.8 | 3.8 | 3.7 | 4.6 |
| diazo | 6.2 | 3.7 | 6.4 | 6.3 | 5.8 |

### Examples 118-121

The amounts of reactant (3-aminothiophenol), co-reactant (sodium nitrite), solvent (ethanol), and co-solvent (perchloric acid) for Examples 118-121 are shown in Table 19. The time of irradiation varied between 20 and 120 minutes. The solvent was ethanol.

TABLE 19

| | | | Example | Example |
|---|---|---|---|---|
| | Example 118 | Example 119 | 120 | 121 |
| reactant (mole) | | | | |
| 3-aminothiophenol | 6.9 10⁻⁴ | 6.9 10⁻⁴ | 6.9 10⁻⁴ | 6.9 10⁻⁴ |
| co-reactant (mole) | | | | |
| sodium nitrite | 6.6 10⁻⁴ | 6.6 10⁻⁴ | 6.6 10⁻⁴ | 6.6 10⁻⁴ |
| solvent (ml) | | | | |
| ethanol | 10.0 | 10.0 | 10.0 | 10.0 |
| co-solvent (mole) | | | | |
| perchloric acid | 1.2 10⁻³ | 1.2 10⁻³ | 1.2 10⁻³ | 1.2 10⁻³ |
| time (min) | 20 | 40 | 60 | 120 |
| XPS (%) | | | | |
| N | 0.4 | — | 0.5 | 0.9 |
| diazo | 0.9 | 1.7 | 2.2 | 1.5 |

### Example 122

### Prior Treatment of the Nanotubes

100 mg of NC7000 MWNT nanotube (Nanocyl) were weighted in a 20 ml scintillation flask (opening diameter 16 mm). 10 ml of a mixture of 3/1 sulfuric acid (98%) and nitric acid (70%) was added. The mixture was stirred (700 rpm) and kept under IR irradiation during 30 minutes. The resulting carbon nanotubes were then extensively washed with distillated water until a neutral pH was obtained.

1. A process for preparing covalently grafted carbonaceous material, comprising the steps of:
(a) providing carbonaceous material;
(b) providing at least one reactant;
(c) mixing the carbonaceous material with the at least one reactant, thereby obtaining a mixture; and
(d) irradiating the mixture obtained in step (c) under IR radiation;
thereby obtaining covalently grafted carbonaceous material.

2. The process according to claim 1, wherein the carbonaceous material is selected from the group consisting of carbon nanotubes, fullerenes, carbon black, nanographene, and nanographite.

3. The process according to claim 1, wherein the carbonaceous material comprises carbon nanotubes.

4. The process according to claim 1, wherein the at least one reactant is selected from the group consisting of: R¹—NH₂, R²—CH═CH₂, R³—Si(OR⁴)₃, (R⁵)₃—SiOR⁶, and R⁷—N⁺≡N X⁻, lactide, polylactide;
wherein R¹ is selected from the group consisting of C₆₋₁₀aryl, C₁₋₂₄ alkyl, C₂₋₂₄alkenyl, C₆₋₁₀aryl-C₁₋₆ alkyl and C₁₋₆ alkyl-C₆₋₁₀aryl, and wherein R¹ may be optionally substituted with one or more substituents each independently selected from the group consisting of —OH, haloC₁₋₁₀alkyl, C(O)OH, —SH, —NO₂, heteroaryl, C₁₋₂₄ alkyl, C₂₋₂₄alkenyl, C₆₋₁₀aryl, C₆₋₁₀aryl-C₁₋₆ alkyl, C₁₋₆ alkyl-C₆₋₁₀aryl, and halogen;
wherein R² is selected from the group consisting of C₁₋₂₄alkyl, C₂₋₂₄alkenyl, C₆₋₁₀aryl, C₆₋₁₀aryl-C₁₋₆alkyl and C₁₋₆ alkyl-C₆₋₁₀aryl, and wherein R² may be optionally substituted with one or more substituents each independently selected from the group consisting of —OH, haloC₁₋₁₀alkyl, C(O)OH, —SH, —NO₂, heteroaryl, C₁₋₂₄alkyl, C₂₋₂₄alkenyl, C₆₋₁₀aryl, C₆₋₁₀aryl-C₁₋₆alkyl, C₁₋₆alkyl-C₆₋₁₀aryl, and halogen;
wherein R³ is selected from the group consisting of C₁₋₂₄alkyl, C₂₋₂₄alkenyl, C₆₋₁₀aryl, C₆₋₁₀aryl-C₁₋₆alkyl and C₁₋₆alkyl-C₆₋₁₀aryl, and wherein R³ may be optionally substituted with one or more substituents each independently selected from the group consisting of —OH, haloC₁₋₁₀alkyl, C(O)OH, —SH, —NO₂, heteroaryl, C₁₋₂₄alkyl, C₂₋₂₄alkenyl, C₆₋₁₀aryl, C₆₋₁₀aryl-C₁₋₆alkyl, C₁₋₆alkyl-C₆₋₁₀aryl, hydrogen, and halogen;
wherein each R⁴ is independently C₁₋₆ alkyl optionally substituted with one or more substituents each independently selected from the group consisting of —OH, haloC₁₋₁₀alkyl, C(O)OH, —SH, —NO₂, heteroaryl, C₁₋₂₄alkyl, C₂₋₂₄alkenyl, C₆₋₁₀aryl, C₆₋₁₀aryl-C₁₋₆alkyl, C₁₋₆ alkyl-C₆₋₁₀aryl, and halogen;
wherein each R⁵ is independently selected from the group consisting of: C₁₋₂₄alkyl, C₂₋₂₄alkenyl, C₆₋₁₀aryl, C₆₋₁₀aryl-C₁₋₆alkyl and C₁₋₆alkyl-C₆₋₁₀aryl, and wherein R⁵ may be optionally substituted with one or more substituents each independently selected from the group consisting of —OH, haloC₁₋₁₀alkyl, C(O)OH, —SH, —NO₂, heteroaryl, C₁₋₂₄alkyl, C₂₋₂₄alkenyl, C₆₋₁₀aryl, C₆₋₁₀aryl-C₁₋₆ alkyl, C₁₋₆ alkyl-C₆₋₁₀aryl, hydrogen, and halogen;
wherein R⁶ is C₁₋₆ alkyl, and is optionally substituted with one or more substituents each independently selected from the group consisting of —OH, haloC₁₋₁₀alkyl, C(O)OH, —SH, —NO₂, heteroaryl, C₁₋₂₄alkyl, C₂₋₂₄alkenyl, C₆₋₁₀aryl, C₆₋₁₀aryl-C₁₋₆ alkyl, C₁₋₆alkyl-C₆₋₁₀aryl, and halogen;
wherein R⁷ is selected from the group consisting of C₁₋₂₄alkyl, C₂₋₂₄alkenyl, C₆₋₁₀aryl, C₆₋₁₀aryl-C₁₋₆alkyl and C₁₋₆alkyl-C₆₋₁₀aryl, and wherein R⁷ may be optionally substituted with one or more substituents each independently selected from the group consisting of —OH, haloC₁₋₁₀alkyl, C(O)OH, —SH, —NO₂, heteroaryl, C₁₋₂₄alkyl, C₂₋₂₄alkenyl, C₆₋₁₀aryl, C₆₋₁₀aryl-C₁₋₆alkyl, C₁₋₆alkyl-C₆₋₁₀aryl, and halogen; and
wherein X⁻ is an organic or inorganic anion.

5. The process according to claim 1, wherein the at least one reactant is selected from the group consisting of substituted aniline, aniline, diazonium salts, primary aliphatic amines, styrene, and lactide.

6. The process according to claim 1, wherein the at least one reactant is a substituted aniline.

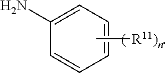

7. The process according to claim 1, wherein the at least one reactant is a compound of formula (II) or (III): 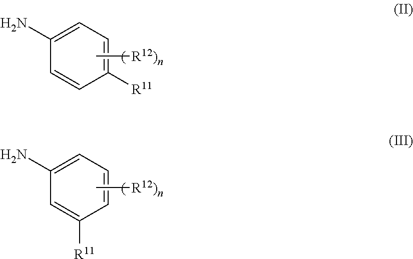
wherein R¹¹ is hydrogen, halogen, or —NO₂, or is a group selected from the group consisting of —OH, haloC₁₋₁₀alkyl, —C(O)OH, —SH, heteroaryl, C₁₋₂₄ alkyl, C₂₋₂₄alkenyl, C₆₋₁₀aryl, C₆₋₁₀aryl-C₁₋₆ alkyl, C₁₋₆ alkyl-C₆₋₁₀aryl, each group being optionally substituted by one or more substituents each independently selected from the group consisting of halogen, or C₁₋₆ alkyl,
wherein each R¹² is independently hydrogen, halogen, or —NO₂, or is a group selected from the group consisting of —OH, haloC₁₋₁₀alkyl, —C(O)OH, —SH, heteroaryl, C₁₋₂₄ alkyl, C₂₋₂₄alkenyl, C₆₋₁₀aryl, C₆₋₁₀aryl-C₁₋₆ alkyl, C₁₋₆ alkyl-C₆₋₁₀aryl, each group being optionally substituted by one or more substituents each independently selected from the group consisting of halogen, or C₁₋₆ alkyl,
and wherein n is an integer selected from 1, 2, 3, or 4.

8. The process according to claim 1, wherein the IR radiation has a wavelength of at least 0.75 μm and at most 3.00 μm.

9. The process according to claim 1, wherein step (d) has a duration of at least 10 minutes and at most 240 minutes.

10. The process according to claim 1, wherein step (c) further comprises the step of mixing the carbonaceous material with a co-reactant.

11. The process according to claim 1, wherein step (c) further comprises the step of mixing the carbonaceous material with liquid or gaseous solvent.

12. The process according to claim 11, wherein the solvent is selected from the group consisting of: water, acetonitrile, ethanol, pyridine, aliphatic hydrocarbons, aromatic hydrocarbons, nitrogen, argon, and helium.

13. The process according to claim 1, wherein step (c) further comprises mixing the carbonaceous material with liquid or gaseous co-solvent.

14. A process for preparing a polymeric composite, comprising the steps of:
(a) providing a polymer composition comprising at least one polymer;
(b) providing at least 0.001% by weight of the covalently grafted carbonaceous material prepared according to the process of claim 1, relative to a total weight of the polymeric composite;
(c) blending the covalently grafted carbonaceous material with the polymer composition, thereby obtaining a polymeric composite.

15. The covalently grafted carbonaceous material obtained by a process according to claim 1.

16. The polymeric composite obtained by the process according to claim 14.

17. The process according to claim 1, wherein the at least one reactant is a compound of formula (I): 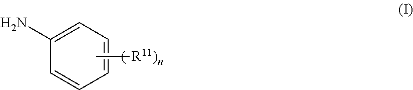
wherein each R¹¹ is independently hydrogen, halogen, or —NO₂, or is a group selected from the group consisting of —OH, haloC₁₋₁₀alkyl, —C(O)OH, —SH, heteroaryl, C₁₋₂₄ alkyl, C₂₋₂₄alkenyl, C₆₋₁₀aryl, C₆₋₁₀aryl-C₁₋₆ alkyl, C₁₋₆ alkyl-C₆₋₁₀aryl, each group being optionally substituted by one or more substituents each independently selected from the group consisting of halogen, or C₁₋₆ alkyl, wherein n is an integer selected from 1, 2, 3, 4 or 5.
